(19) United States
(12) Patent Application Publication
(10) Pub. No.: US 2025/0310271 A1
(43) Pub. Date: Oct. 2, 2025

(54) METHOD AND APPARATUS FOR MANAGEMENT OF CREDITS IN A CREDIT-BASED FABRIC

(71) Applicant: Intel Corporation, Santa Clara, CA (US)

(72) Inventors: Omprakash BISEN, Bangalore (IN); Pattabhiraman K, Bangalore (IN); Jayakrishna S, Bangalore (IN); Anish SATISH KUMAR, Bangalore (IN)

(21) Appl. No.: 18/619,124

(22) Filed: Mar. 27, 2024

(51) Int. Cl. H04L 47/10

(52) U.S. Cl. CPC H04L 47/39

(57) ABSTRACT

Methods, apparatus, and computer programs are disclosed for credit management for a credit-based fabric. In one embodiment, a method is disclosed to perform broadcasting a first plurality of credit grants to a plurality of circuits based on availability of credits for packet transmission to a first circuit through a fabric. The method further comprises receiving a credit request from a second circuit to obtain a credit for packet transmission of a traffic class to the first circuit, and responsive to the credit request and based on available credits dedicated to or shared with the traffic class, performing: sending a credit grant only to the second circuit for packet transmission of the traffic class to the first circuit, or broadcasting a second plurality of credit grants to the plurality of circuits for packet transmission to the first circuit of the traffic class, including a credit grant to the second circuit.

### TECHNICAL FIELD

Embodiments of the disclosure relate to the field of computing; and more specifically, the embodiments are related to management of credit in a credit-based fabric.

### BACKGROUND ART

In a multi-sender credit-based fabric of a computing system, traffic is transmitted by a sender circuit of the multiple sender circuits to a target circuit based on available credits to the target circuit. A sender or target circuit may also be referred to as a sender or target client, a sender or target node/component/entity, or simply a sender or target, respectively; and these pairs of terms are used interchangeably herein.

To manage the transmission, credits can be reserved for each traffic class and each sender, and all senders consume their reserved credits, respectively. Yet reserving credits for each sender and each traffic class results in a very large buffer storage for the target, and the large buffer storage can be wasteful and even impractical to implement.

Alternatively, credits may be released by the target based on the available buffer storage for the target. These credits can be dedicated for a traffic class or shared credits for all traffic classes. These credits are granted to senders responsive to sender credit requests, where the credit consumption is managed by a credit manager of the target. To meet timing requirements for credit distribution, the credit manager performs a multi-stage credit arbitration, including (1) receiving a credit request from a sender, (2) performing a credit arbitration to determine whether a credit is available for the sender, (3) sending a credit grant to the sender when a credit is available, (4) waiting on the credit to be consumed by the sender as the sender transmits a packet to the target using the granted credit, and (5) waiting on the credit to be released back to the credit pool once the corresponding packet has been received at the target. The multi-stage credit arbitration takes time and storage resources and can cause packet processing bottlenecks, particularly at high workload.

### BRIEF DESCRIPTION OF THE DRAWINGS

The disclosure may best be understood by referring to the following description and accompanying drawings that are used to show embodiments of the disclosure.

FIG. 1 illustrates entities for credit management in a credit-based fabric per some embodiments.

FIG. 2 illustrates operations of credit management in a credit-based fabric per some embodiments.

FIG. 3 illustrates a flow diagram for operations of credit management per some embodiments.

FIGS. 4A-4B illustrate a hybrid logical/physical view of a disaggregated parallel processor that implements credit management in a credit-based fabric per some embodiments.

FIG. 5 illustrates a flow diagram for operations of credit management in a credit-based fabric per some embodiments.

FIG. 6 illustrates an example computing system.

FIG. 7 illustrates a block diagram of an example processor and/or System on a Chip (SoC) that may have one or more cores and an integrated memory controller.

FIG. 8 is a block diagram illustrating a computing system configured to implement one or more aspects of the examples described herein.

FIG. 9A illustrates examples of a parallel processor.

FIG. 9B illustrates examples of a block diagram of a partition unit.

FIG. 9C illustrates examples of a block diagram of a processing cluster within a parallel processing unit.

FIG. 9D illustrates examples of a graphics multiprocessor in which the graphics multiprocessor couples with the pipeline manager of the processing cluster.

FIGS. 10A-10C illustrate additional graphics multiprocessors, according to examples.

FIG. 11 shows a parallel compute system 1100, according to some examples.

FIG. 12A is a block diagram illustrating both an example in-order pipeline and an example register renaming, out-of-order issue/execution pipeline according to examples.

FIG. 12B is a block diagram illustrating both an example in-order architecture core and an example register renaming, out-of-order issue/execution architecture core to be included in a processor according to examples.

FIG. 13 illustrates examples of execution unit(s) circuitry, such as execution unit(s) circuitry.

FIGS. 14A-14B illustrate thread execution logic including an array of processing elements employed in a graphics processor core according to examples described herein.

FIG. 15 is a block diagram of another example of a graphics processor.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “connected” means a direct electrical or magnetic connection between the things that are connected, without any intermediary devices, while the term of “coupled” means either a direct electrical or magnetic connection between the things that are connected or an indirect connection through one or more passive or active intermediary devices. The term “circuit” means one or more passive and/or active components that are arranged to cooperate with one another to provide a desired function. The terms “computing system,” “compute system,” “computer system,” and “computer” are used interchangeably herein. The term “set” means any positive whole number of items including one item.

### Credit Management

To manage credits in a credit-based fabric of a computing system, a credit manager may be used to distribute credits through a multi-stage credit arbitration discussed in the background section above. Such a credit arbitration, while allowing the credit manager to meet the timing requirement to process credit requests, increases the minimum credit requirement thus requiring more buffer storage for a target. The multi-stage credit arbitration also increases latency of completing the credit processing; and when credit availability is low, fairness among senders may be lost as credits are granted based on client requests, yet the sender required traffic class may not have credit available while available credits for another traffic class are not granted to another sender due to lack of credit request from that sender for that traffic class.

Embodiments of the disclosure implement a credit grant scheme that is adaptive with a broadcast mode and an arbiter mode, and that tracks the already used credits for traffic classes supported by a target. When one or more traffic classes have available credits to be granted for transmitting to a target based on the credit allocations for the target, a corresponding credit manager may operate in a broadcast mode and broadcast credit grants for the available credits to multiple senders that may have traffic to be transmitted to the target. When a traffic class has less than its respective allocation (e.g., credits for the traffic class below a threshold level), the credit manager may operate in an arbiter mode and provide credit grants for the traffic class only to the one or more senders that have sent credit requests for transmitting to the target.

The credit manager may alternate between the broadcast mode and arbiter mode for a traffic class based on the availability level of the credits for the target. The availability of the credits for the target is based on how occupied the target is at processing the delivered traffic corresponding to the granted credits in some embodiments. When the target finishes processing traffic from a sender, the corresponding credits granted to the sender, which has subsequently consumed the credits to transmit the traffic, are to be released, and the released credits are then made available for the credit manager to distribute for future traffic transmission. The availability of the credits at the credit manager thus corresponds to the target's request fill level. When the target's request fill level is low, meaning existing traffic is insufficient to occupy the target's resources (e.g., the fill level may correspond to the consumed/available amount or percentage of storage resources, processing/execution resources, and/or transmission/communication bandwidth for the target to process the existing traffic), the credit manager may operate in the broadcast mode and broadcast credit grants to multiple senders, so that more traffic from the senders may be transmitted sooner to the target and utilize the target's resources. On the other hand, when the target's fill level is high, meaning existing traffic is using sufficient target's resources, the credit manager may operate in the arbiter mode and provide credit grants responsive only to a credit request.

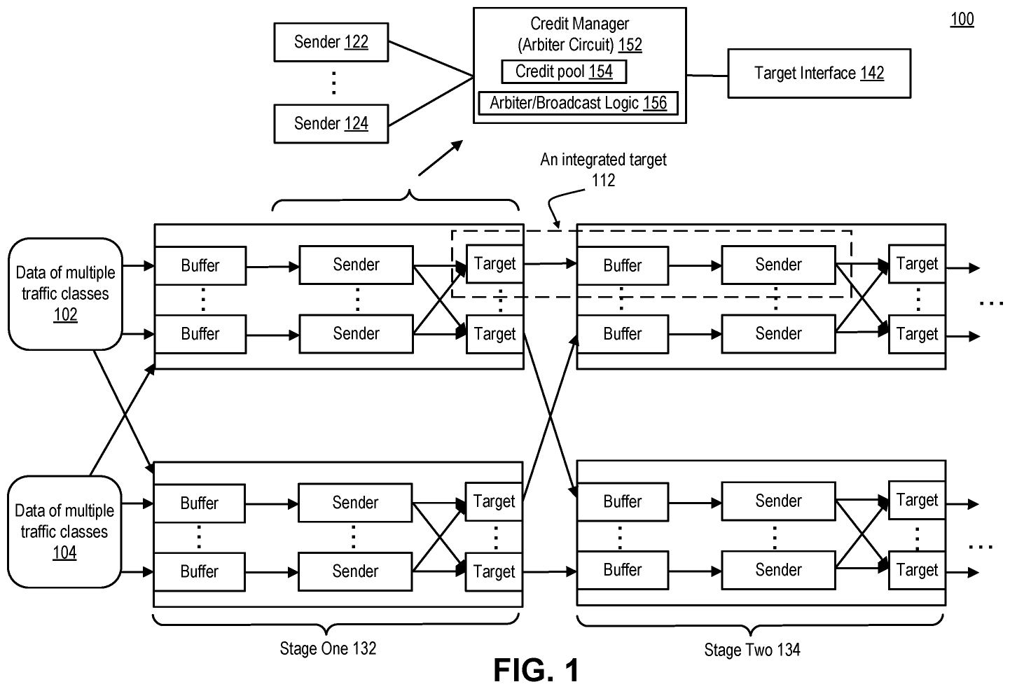

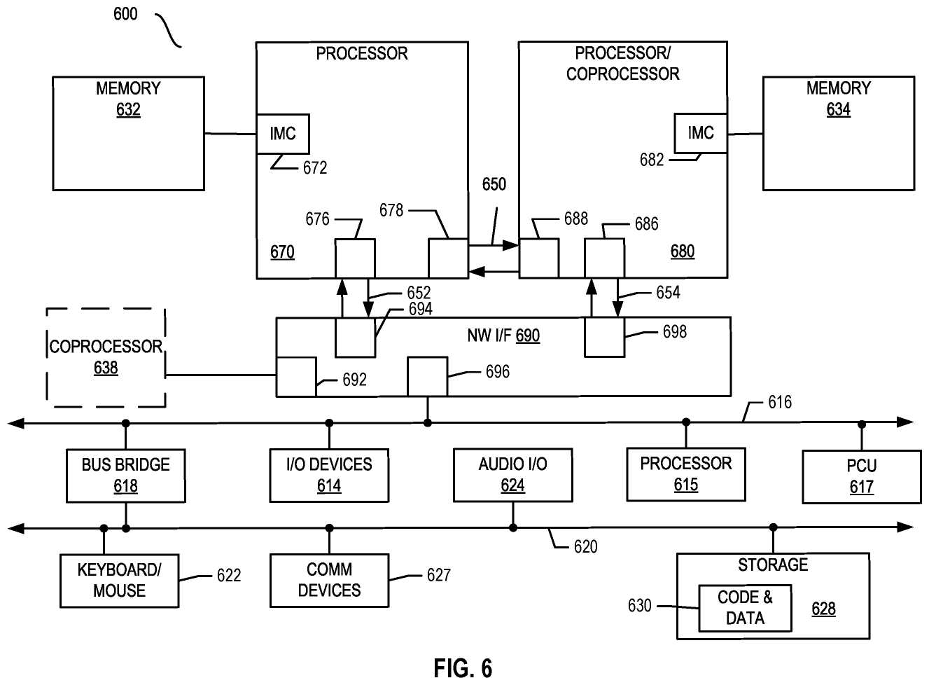

FIG. 1 illustrates entities for credit management in a credit-based fabric per some embodiments. System 100 may be a part of a computing system/processor discussed herein relating to FIGS. 6 to 14. The sender and target are circuits/nodes/components/entities within the computing system/processor, and a communication link connects/couples a sender with a target is a communication link within a credit-based fabric.

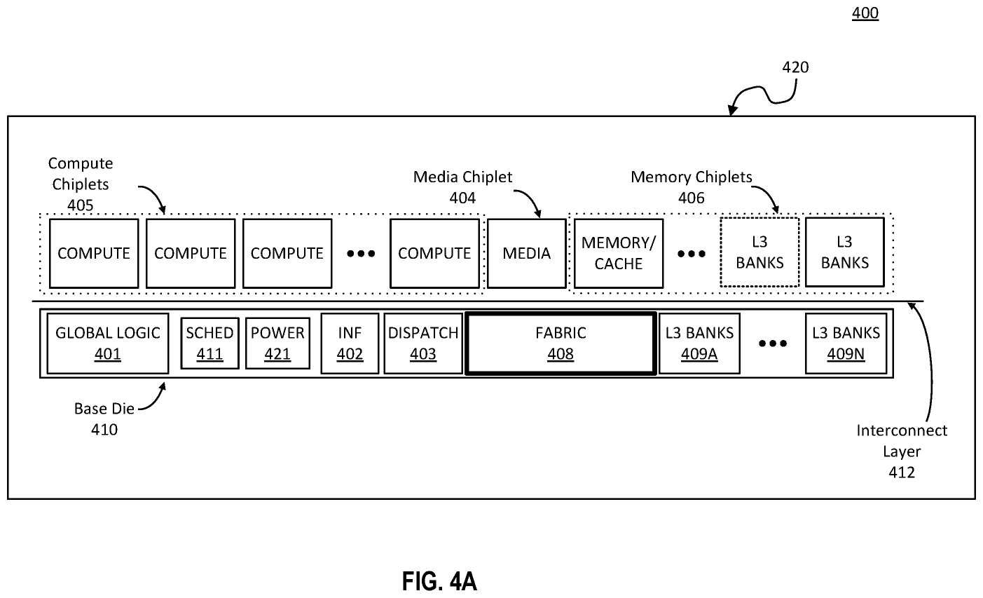

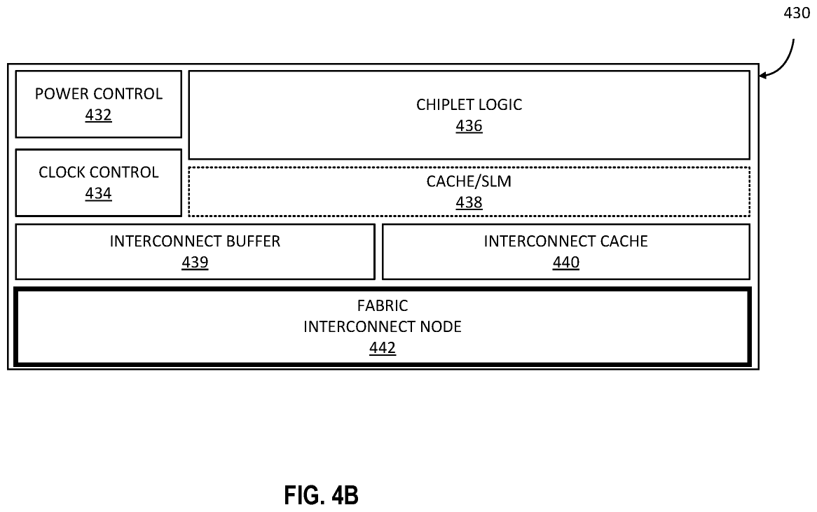

A credit-based fabric may include multiple stages, and FIG. 1 shows two stages of the fabric, Stage One 132 and Stage Two 134. More stages may be included in the fabric in some embodiments, and alternatively a system may include only one stage in some embodiments. The fabric may be a part of fabric 408 within FIG. 4A or fabric interconnect node 442 within FIG. 4B (further details are explained herein below relating to FIGS. 4A-4B), while the fabric may include link connects circuits/nodes/components/entities within other computing system/processor in alternative embodiments.

A credit-based fabric provides a pathway for traffic to be transmitted from one initial sender to an eventual target. The pathway may include multiple stages with intermediary senders and targets. For example, for a load operation, the initial sender circuit of the first stage is a storage (e.g., a system memory or L1/L2/L3 cache) and the eventual target circuit of the last stage is a processing unit (e.g., a central processing unit (CPU) core or a graphics processing unit (GPU) core, an executing engine, or a compute chiplet). For a store operation, the pathway is in the reverse direction, and the initial sender circuit is the processing unit and the eventual target circuit is the storage. In the intermediate stages, the senders and targets may be circuits/nodes/components/entities on the pathway. For example, the intermediary senders/targets may include one or more of fabric host adapters, fabric switches, fabric endpoint adapters, fabric attached memory, fabric attached accelerators, and other circuits.

The data of multiple traffic classes are provided to buffers of Stage One 132 and they are shown with references 102 and 104, each from one or more data sources of a computing system. The multiple traffic classes each may have its own quality of service (QoS) requirements (e.g., a maximum latency allowed and/or minimum bandwidth required). For example, the multiple traffic classes may include real-time traffic (e.g., video/audio streaming), high-priority traffic (e.g., system interrupts), normal traffic (e.g., user application and computation), and low-priority traffic (e.g., background tasks or housekeeping operations). Because of the different QoS requirements, they are handled differently in the credit-based fabric, and different number of credits may be reserved for each traffic class, and a credit manager may operate at different broadcast/arbiter mode for different traffic classes to the same target as discussed in further details herein below.

In some embodiments, the data are transmitted within packets, and the term “packet” is intended to be broadly construed to include a frame, a datagram, a packet, or a cell; a fragment of a frame, a fragment of a datagram, a fragment of a packet, or a fragment of a cell; or another type, arrangement, or packaging of data. A sender is to send packets stored in a buffer coupled with the sender to its corresponding target. In the credit-based fabric, a sender is allowed to transmit one or more packets to a target if the sender is granted one or more credits for transmitting to the target. To simplify discussion, the discussion herein uses the example of one credit allowing the transmission of one packet from a sender to its corresponding target, but one credit may allow the sender to send multiple packets to the target. For the same reason, the packets to be transmitted within the credit-based fabric are assumed to have the same length, yet the packets may have different lengths in alternative embodiments.

In the multi-stage fabric, a target in a stage may share a buffer with a sender in the immediate next stage. For example, the targets in Stage One 132 share their buffers with the senders in Stage Two 134. In some embodiments, an integrated target may include the target of the earlier stage, the shared buffer, and the sender in the next stage, as shown in integrated target 112.

Note that a packet may have multiple path options to be transmitted through the multiple stages of the fabric. For example, a packet at reference 102 may be transmitted through one of the upper sender-target pairs for Stage One 132, and then one of the lower sender-target pairs for Stage Two 134; or it may be transmitted through one of the lower sender-target pairs for Stage One 132, and then one of the upper sender-target pairs for Stage Two 134. In some embodiments, any of the path options are acceptable, as long as the packet arrives at the eventual target. Thus, in these embodiments, a sender may select one credit grant from multiple credit grants each for a different target, and a given target's credit grant may be discarded by the sender.

The entities for the operations between a sender and target pairing are shown at the top of FIG. 1 through zooming in on a sender-target pair of Stage One 132. As shown, multiple senders 122 to 124 are managed by a credit manager 152, which manages credit grant for a target based on availability of its target interface 142 for accepting packets from senders to process. Credit manager 152 maintains a credit pool 154, and based on the availability of credits for a traffic class, arbiter/broadcast logic 156 within credit manager 152 operates either as an arbiter for the traffic class and transmits one or more corresponding credit grants to a sender only responsive to credit requests from the sender, or as a broadcaster for the traffic class and broadcasts corresponding credit grants to multiple senders regardless, including a sender that has not sent a credit request for transmitting to the target in the traffic class. Credit manager 152 may manage one or more targets, and it may be implemented as a standalone circuit and referred to as an arbiter circuit 152. Arbiter circuit 152 may be integrated with an existing circuit, e.g., one within a credit-based fabric, a target circuit, or another control circuit of the credit-based fabric in some embodiments.

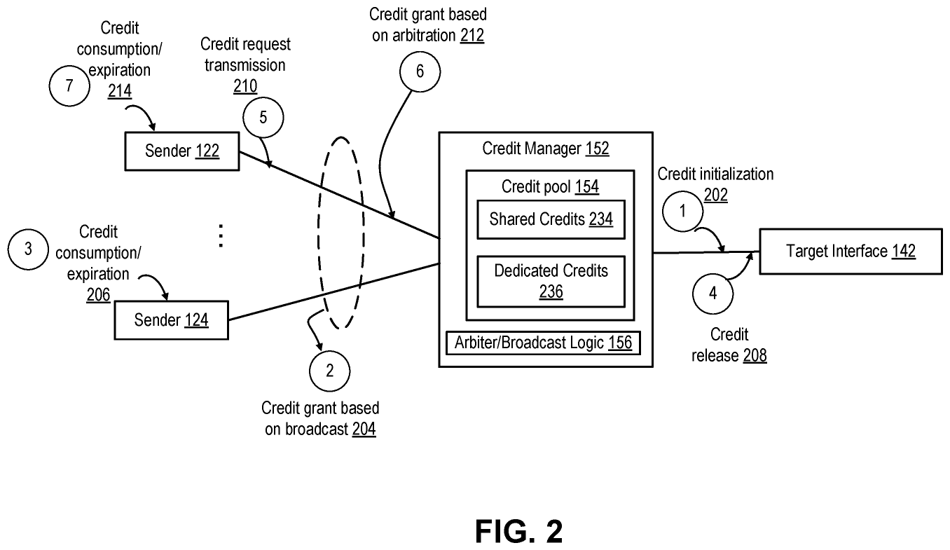

FIG. 2 illustrates operations of credit management in a credit-based fabric per some embodiments. FIG. 2 shows entities in a portion of FIG. 1 and the same references indicate the corresponding elements or components having the same functionalities. Circles 1 to 7 illustrate the order in which operations are performed according to some embodiments.

At Circle 1 (reference 202), credit pool 154 is initialized based on target interface 142. The initialization may happen when the corresponding target is brought in service or reset and is ready to process packets transmitted from senders. The target interface may indicate how many credits are released for packet transmission to the target. Since the target just comes to service, the full amount of credits should be released and made available in credit pool 154 for the target. For the target, Credit manager 152 may maintain one or more counters to count the credits that are used or still available, and the counter increases and decreases based on how many credits are used for transmitting packets to the target. The credits may be categorized as (1) shared credits 234 that are shared among all/subset of traffic classes to be served by the target and (2) dedicated credits 236 each for a specific traffic class. The sizes of the shared credits 234 and dedicated credits 236 are implement-dependent and may change based on traffic classes and application involved for the transmission in the fabric. Credit manager 152 may maintain a counter for credits dedicated to each traffic class (traffic class specific counters), and a counter for credits shared among a plurality of classes (e.g., a first counter for credits shared between TC1 and TC2, and a second counter for credits shared TC1 and TC3, and etc.) in some embodiments.

At Circle 2 (reference 204), credit manager 152 broadcasts credit grants to multiple senders including senders 122 to 124, regardless of whether credit manager 152 has received credit requests from the senders. The credit grants correspond to shared credits and/or dedicated credits for transmission to target interface 142. The number of shared credits and/or dedicated credits to be distributed in the broadcast mode may be based on credit allocations. For example, Traffic Class 1 (TC1) may be allowed to use all credits dedicated to TC1 and half of the shared credits, and Traffic Class 2 (TC2) may be allowed to use all credits dedicated to TC2 and a quarter of the shared credits. Credit manager 152 may broadcast credit grants to allow the senders to use (1) all credits dedicated to TC1 and TC2 and (2) half of the shared credits. Alternatively, credit manager 152 may broadcast credit grants to allow the senders to use (1) 80% and 70% credits dedicated to TC1 and TC2, respectively, and (2) all of the shared credits. How many credits are to be distributed in the broadcast mode may be based on implementation and may be determined through machine learning or heuristic methods, so that the thresholds of credit distribution in the broadcast mode may be configured.

For example, one or more machine learning models may be implemented to determine the optimal credit distribution thresholds for shared credits and dedicated credits for each traffic class in the broadcast mode. The machine learning models may use supervised learning, unsupervised learning, semi-supervised learning, or other types of learning. They can use artificial neural networks, decision trees, support-vector machines, regression analysis, Bayesian networks, genetic algorithms, or any other framework. The machine learning models may be trained with the one or more goals of increasing the packet transmission rate, using the minimum storage/execution/bandwidth resources of the computing system in the packet forwarding through the fabric, and/or reducing retransmission of packets through the fabric. The output of the machine learning model may be the optimal credit distribution thresholds for both dedicated credits and shared credits during the broadcast mode, based on the input of credits allocated to dedicated credits and shared credits. The determined credits for both dedicated credits and shared credits for each traffic class are then configured for the credit manager 152 to distribute using the corresponding credit grants, where each credit grant may correspond to one or more available credits.

At Circle 3 (reference 206), a sender (sender 124 in this example) accepts a credit grant from the credit grants it receives through the broadcast and uses the corresponding credit (or credits) to transmit a packet (or packets) toward target interface 142. Once the credit is used (also referred to as consumed, and the two terms are used interchangeably), credit manager 152 is notified (e.g., through an acknowledgment message upon acceptance of the credit grant) and the credit counter at credit manager 152 is deducted with the amount of consumed credits. Also at Circle 3, the credit grants transmitted in the broadcast mode to the multiple senders may not be accepted. For example, since a sender may get to the next stage of the multi-stage fabric through multiple targets, the sender may ignore the credit grants for the particular target. A timer may be set for the acceptance of the credit grant, and the expiration of the timer causes the credit grant to expire, and corresponding credit (or credits) that would be consumed had the credit grant been accepted by a sender becomes available at credit pool 154.

At Circle 4 (reference 208), the sender completes transmission of packet (or packets) using the corresponding credit (or credit) to target interface 142, and the target processes the packet and stores the packet to a coupled buffer; since the packet no longer uses the fabric, target interface 142 may notify credit manager 152, e.g., by issuing a credit release indication to credit manager 152, and the released credit, being shared or dedicated, may be released back to credit pool 154.

In the operations of the credit-based fabric, a sender (sender 122 in this example) may have packets to transmit and do not receive a credit grant for the packet. For example, the packets at sender 122 are TC1 packets but only credit grant(s) for TC2 is received by sender 122. At Circle 5 (reference 210), sender 122 then transmits a credit request to credit manager 152. The credit request 210 may indicate (1) how many credits sender 122 needs to transmit its packets (e.g., when one credit is for one packet and sender 122 has three packets to transmit, three credits are indicated) and (2) what is the traffic class the packet is to be transmitted (TC1 in this example).

Upon receiving the credit request, credit manager 152 checks the credit pool 154 and determines whether the available credits in shared credits 234 and dedicated credits 236 for TC1 are sufficient for broadcasting. For example, the threshold for broadcasting dedicated credits of TC1 is 80% of allocated credits to TC1 and currently 30% dedicated credits of TC1 are available (assuming no shared credits are available), credit manager 152 may broadcast credit grants to distribute 10% credits dedicated to TC1, as that would reduce the remaining dedicated credits of TC1 to 20%, complying with the threshold of 80% broadcasting. The broadcast by credit manager transmits credit grants to multiple senders, including the one sending the credit request, sender 122 in this example.

However, the available credits in shared credits 234 and dedicated credits 236 for TC1 are insufficient for broadcasting, the operation goes to Circle 6, where credit manager 152 operates in arbiter mode, and provide credit grants only responsive to the sender that sent the credit request. Following the example of the previous example, if the threshold for broadcasting dedicated credits of TC1 is 80% of allocated credits to TC1 and currently 10% dedicated credits of TC1 are available (assuming no shared credits are available), credit manager 152 no longer can broadcast a credit grant for TC1 but send only credit grant(s) to sender 122 based on availability of dedicated credits of TC1.

At Circle 7, similar to the operation of Circle 3, the corresponding credit may be consumed, or the credit grant may expire based on whether the credit is used at sender 122. After the credit(s) is consumed and corresponding packet(s) are transmitted to target interface 142, the credit(s) is released and returned to credit pool 154. Similarly, if the corresponding credit grant(s) expires, the credit(s) is returned to credit pool 154.

After the credit return, the available credits in pool 154 are changed, and credit manager 152 may again operate at a broadcast mode, for TC1 or another traffic class.

Note that in the arbiter mode, credit manager 152 does arbitration based on credit requests for traffic classes from senders. Credit manager 152 makes sure that credits are granted to a sender only if the sender has requested a traffic class with available credits. The process of arbitration takes more interactions between a sender and a target thus may take a longer time and consume more resources in the interaction than the process of broadcasting. By implementing the broadcast mode when credits are available and switching to the arbiter mode only when credits need to be distributed more carefully, the overall credit allocation becomes more efficient in a credit-based fabric.

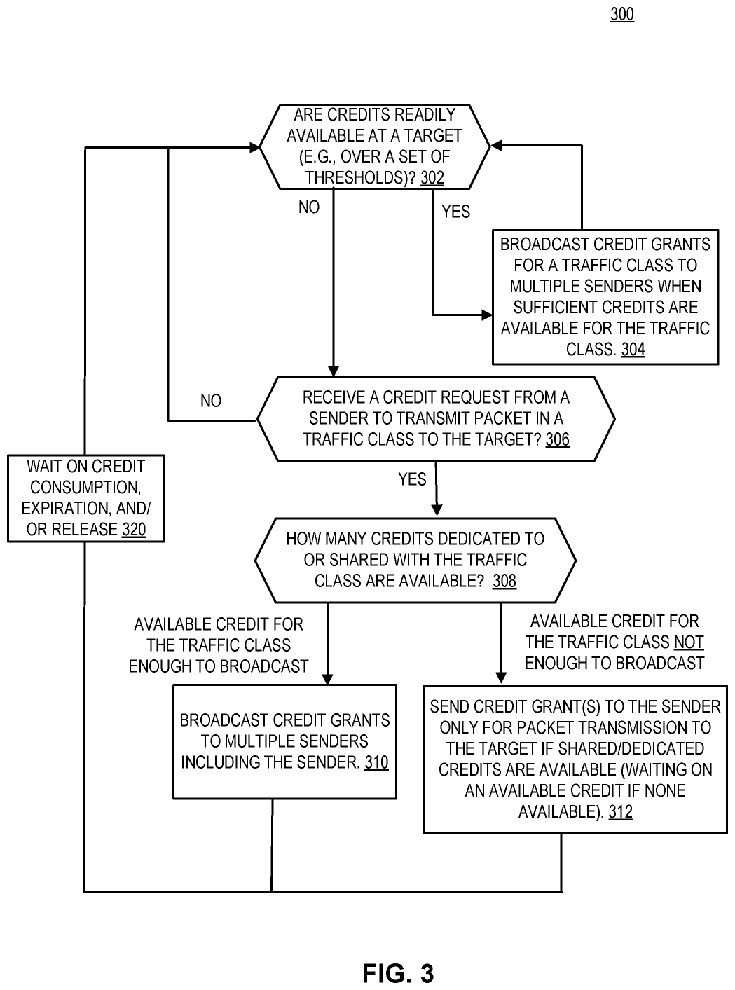

FIG. 3 illustrates a flow diagram for operations of credit management per some embodiments. The operations are performed by a credit manager (e.g., credit manager 152). At reference 302, the credit manager determines whether credits are readily available at a target for which the credit manager manages credits in a credit-based fabric. In some embodiments, the credits are deemed readily available when the number of available credits (ones that have not been used and may be distributed to senders to transmit packets to the target) are over their corresponding thresholds, either for credits shared among all or subset of traffic classes or credits dedicated to a particular one or more traffic classes.

If the credits are readily available for a traffic class, the flow goes to reference 304, where the traffic manager broadcasts credit grants for the traffic class to multiple senders. Once the credit grants issues corresponding number of credits to reach the corresponding credit threshold for the traffic class, the credit manager no longer issues further credit grants until more credits are released for the traffic class (dedicated to or shared with the traffic class). The credit manager returns to reference 302 for the release.

If no credits are readily available for a traffic class, the traffic manager waits until receiving a credit request from a sender to transmit a packet in a traffic class to the target. At reference 306, the traffic manager determines whether the credit request is received, if not, the flow returns to reference 302. If it does receive the credit request, the flow goes to reference 308, the credit manager checks how many credits either dedicated to or shared with the traffic class are available. If the number of available credits is enough for broadcasting credit grant to transmit packets in the traffic class, the flow goes to reference 310, where the credit manager broadcasts credit grants to multiple senders including the sender that transmitted the credit request. If not, the flow goes to reference 312, where the credit manager operates in the arbiter mode and one or more credit grants may be sent only to the sender that transmitted the credit request when shared/dedicated credits for the traffic class are available, and the target manager waits for an available credit if no shared/dedicated credits for the traffic class can be found.

Once the credit grant(s) is transmitted, through either broadcast or arbiter mode, the flow goes to reference 320, where the credit manager waits for the consumption and release of the corresponding credit(s), or the expiration of the credit grant. After the credit(s) is released or the credit grant(s) expires, the available credits in the credit pool of the credit manager changes, and the flow returns to reference 302 and the process starts again.

The embodiments may be implemented in a variety of computing systems, including ones with chiplet-based design. FIGS. 4A-4B illustrate a hybrid logical/physical view of a disaggregated parallel processor that implements credit management in a credit-based fabric per some embodiments. FIG. 4A illustrates a disaggregated parallel computing system 400. FIG. 4B illustrates a chiplet 430 of the disaggregated parallel computing system 400.

As shown in FIG. 4A, a disaggregated computing system 400 can include a parallel processor 420 in which the various components of the parallel processor SoC are distributed across multiple chiplets. Each chiplet can be a distinct IP core that is independently designed and configured to communicate with other chiplets via one or more common interfaces. The chiplets include but are not limited to compute chiplets 405, a media chiplet 404, and memory chiplets 406. Each chiplet can be separately manufactured using different process technologies. For example, compute chiplets 405 may be manufactured using the smallest or most advanced process technology available at the time of fabrication, while memory chiplets 406 or other chiplets (e.g., I/O, networking, etc.) may be manufactured using larger or less advanced process technologies.

The various chiplets can be bonded to a base die 410 and configured to communicate with each other and logic within the base die 410 via an interconnect layer 412. In some examples, the base die 410 can include global logic 401, which can include scheduler 411 and power management 421 logic units, an interface 402, a dispatch unit 403, and an interconnect fabric module 408 coupled with or integrated with one or more L3 cache banks 409A-409N. The interconnect fabric 408 can be an inter-chiplet fabric that is integrated into the base die 410. Logic chiplets can use fabric 408 to relay messages between the various chiplets. Additionally, L3 cache banks 409A-409N in the base die and/or L3 cache banks within the memory chiplets 406 can cache data read from and transmitted to DRAM chiplets within the memory chiplets 406 and to system memory of a host. One or more credit managers (e.g., credit manager 152) may manage fabric 408 as a credit-based fabric and perform the operations discussed herein, and the credit managers be integrated within the interconnect fabric 408 or target circuits (e.g., compute chiplets 405, media chiplet 404, memory chiplets 406, or L3 banks 409A-N), or stand alone as a separate circuit/logic/chiplet on the base die or within interconnect layer 412.

In some examples, the global logic 401 is a microcontroller that can execute firmware to perform scheduler 411 and power management 421 functionality for the parallel processor 420. The microcontroller that executes the global logic can be tailored for the target use case of the parallel processor 420. The scheduler 411 can perform global scheduling operations for the parallel processor 420. The power management 421 functionality can be used to enable or disable individual chiplets within the parallel processor when those chiplets are not in use.

The various chiplets of the parallel processor 420 can be designed to perform specific functionality that, in existing designs, would be integrated into a single die. A set of compute chiplets 405 can include clusters of compute units (e.g., execution units, streaming multiprocessors, etc.) that include programmable logic to execute compute or graphics shader instructions. A media chiplet 404 can include hardware logic to accelerate media encode and decode operations. Memory chiplets 406 can include volatile memory (e.g., DRAM) and one or more SRAM cache memory banks (e.g., L3 banks).

As shown in FIG. 4B, each chiplet 430 can include common components and application specific components. Chiplet logic 436 within the chiplet 430 can include the specific components of the chiplet, such as an array of streaming multiprocessors, compute units, or execution units described herein. The chiplet logic 436 can couple with an optional cache or shared local memory 438 or can include a cache or shared local memory within the chiplet logic 436. The chiplet 430 can include a fabric interconnect node 442 that receives commands via the inter-chiplet fabric. Commands and data received via the fabric interconnect node 442 can be stored temporarily within an interconnect buffer 439. Data transmitted to and received from the fabric interconnect node 442 can be stored in an interconnect cache 440. Power control 432 and clock control 434 logic can also be included within the chiplet. The power control 432 and clock control 434 logic can receive configuration commands via the fabric can configure dynamic voltage and frequency scaling for the chiplet 430. In some examples, each chiplet can have an independent clock domain and power domain and can be clock gated and power gated independently of other chiplets.

In some embodiments, fabric interconnect node 442 implements a credit-based fabric managed by one or more credit managers (e.g., credit manager 152). The credit managers be integrated within fabric interconnect node 442 or target circuits (e.g., chiplet logic 436, cache/SLM 438, interconnect cache 440, or stand alone as a separate circuit/logic). Note that interconnect buffer 439 may include the buffers shown in FIG. 1.

At least a portion of the components within the illustrated chiplet 430 can also be included within logic embedded within the base die 410 of FIG. 4A. For example, logic within the base die that communicates with the fabric can include a version of the fabric interconnect node 442. Base die logic that can be independently clock or power gated can include a version of the power control 432 and/or clock control 434 logic.

Thus, while various examples described herein use the term SoC to describe a device or system having a processor and associated circuitry (e.g., Input/Output (I/O) circuitry, power delivery circuitry, memory circuitry, etc.) integrated monolithically into a single Integrated Circuit (IC) die, or chip, the present disclosure is not limited in that respect. For example, in various examples of the present disclosure, a device or system can have one or more processors (e.g., one or more processor cores) and associated circuitry (e.g., Input/Output (I/O) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles, and/or chiplets can be physically and electrically coupled together by a package structure including, for example, various packaging substrates, interposers, active interposers, photonic interposers, interconnect bridges, and the like. The disaggregated collection of discrete dies, tiles, and/or chiplets can also be part of a System-on-Package (SoP).

### Operations in Some Embodiments

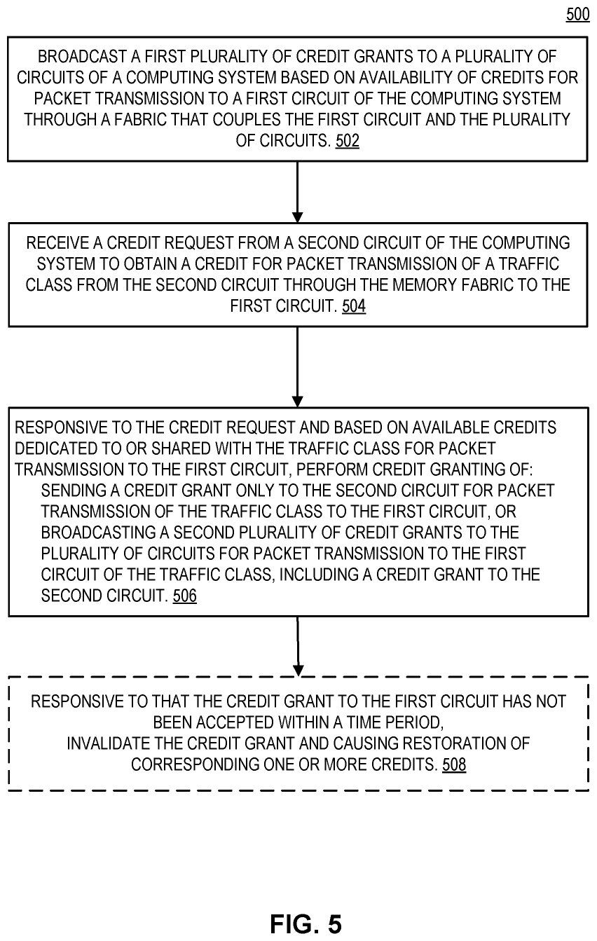

FIG. 5 illustrates a flow diagram for operations of credit management in a credit-based fabric per some embodiments. The operations in method 500 may be performed by a credit manager (e.g., credit manager) of a system (e.g., system 100) discussed herein in some embodiments.

At reference 502, a first plurality of credit grants is broadcast to a plurality of circuits of a computing device based on availability of credits for packet transmission to a first circuit of the computing system through a fabric that couples the first circuit and the plurality of circuits. The first circuit is a target while the plurality of circuits are multiple senders discussed herein.

In some embodiments, the availability of credits is determined based on comparing one or more thresholds with how many credits are available for packet transmission to the first circuit. Each threshold may correspond to the number or percentage of credits dedicated to a traffic class or shared with multiple classes.

In some embodiments, the availability of credits is determined based on a percentage of available credits within credit grants allocated to be dedicated one or more traffic classes or to be shared with multiple traffic classes for packet transmission to the first circuit.

In some embodiments, the first plurality of credit grants is broadcasted to cause a number of remaining credits either dedicated to one or more traffic classes or to be shared with multiple traffic classes for packet transmission to the first circuit to reach respective thresholds.

In the earlier examples of thresholds herein, a credit manager has configured thresholds of 80% and 70% of dedicated credits out of the allocated credits to be dedicated to TC1 and TC2, respectively. When a target (the first circuit) is initiated, it has 100% allocated credits available, and it may broadcast credit grants to distribute 80% and 70% of the dedicated credits for TC1 and TC2, respectively, to reach the respective thresholds.

In some embodiments, the availability of credits is determined based on availability of buffer storage of the first circuit for the packet transmission to the first circuit. The buffer storage of the first circuit is a storage resource of the first circuit, and its availability indicates whether sufficient traffic is processed to occupy the resource of the first circuit (a target). That is, availability of buffer storage of the first circuit corresponds to the first circuit's fill level, and when the fill level is low, more credits are available for distribution, otherwise, fewer credits are available. A threshold of request's fill level may be mapped to a percentage of available/used credits, and it indicates availability of credits, and the credit manager may use the request's fill level to determine (1) whether to broadcast credit grants, and/or (2) how many credits to distribute with the credit grants during broadcast.

In some embodiments, the one or more thresholds are determined based on a machine learning model. The thresholds may be ones for the number and/or percentage of available credits, consumed credits (unavailable credits), the first circuit's request fill level.

At reference 504, a credit request is received from a second circuit of the computing system to obtain a credit for packet transmission of a traffic class from the second circuit through the fabric to the first circuit. At reference 506, responsive to the credit request and based on available credits dedicated to or shared with the traffic class for packet transmission to the first circuit, the credit manager performs credit granting of: sending a credit grant only to the second circuit for packet transmission of the traffic class to the first circuit, or broadcasting a second plurality of credit grants to the plurality of circuits for packet transmission to the first circuit of the traffic class, including a credit grant to the second circuit. Note that the second circuit may be a part of the plurality of circuits of the computing device at reference 502. Alternatively, the second circuit may be another circuit (a new sender) of the computing device outside of the circuits that the first plurality of credit grants was broadcast at reference 502.

In some embodiments, when a number of the available credits dedicated to or shared with the traffic class for packet transmission to the first circuit is below a threshold, the credit grant is to be sent to the second circuit only, otherwise the second plurality of credit grants are broadcast to the plurality of circuits.

In some embodiments, the method further includes, responsive to that the credit grant to the first circuit has not been accepted within a time period, invaliding the credit grant and causing restoration of corresponding one or more credits, as shown at reference 508.

In some embodiments, the available credits dedicated to or shared with the traffic class for packet transmission to the first circuit increases upon completion of processing one or more packets at the first circuit, the one or more packets corresponding to one or more credits granted through the credit grant.

In some embodiments, each of the first and second circuits comprises a processor core, a cache, and a system memory.

Embodiments of the disclosure herein provide credit management in broadcast and arbiter mode to effectively use credits for traffic transmission in multiple traffic classes. For example, for streaming traffic, maximized usage of available credits in the embodiments minimize the depth requirement of intermediate stage in fabric; and for sparse traffic (e.g., low-priority traffic), the arbiter mode is not used in favor of the broadcast mode, and that increase throughput in the credit-based fabric. Additionally, with dedicated and shared credits configured for a target, a traffic class cannot abuse credit consumption by merely entering the fabric early, and the credit distribution in these embodiments are more robust and fairer as a result.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices are also suitable. In general, a variety of systems or electronic devices capable of incorporating a processor and/or other execution logic as disclosed herein are generally suitable, and the embodiments are not limited to these exemplary systems and processors.

### Example Systems

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, mesh, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect Express (PCIe) interconnect, Compute Express Link (CXL), NVLink, HyperTransport, or another I/O interconnect. In some examples, first interface 616 is coupled to a power control unit (PCU) 617, which may include circuitry, software, and/or firmware to perform power management operations with regard to the processors 670, 680 and/or coprocessor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to the second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement a storage in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

In some examples, the LB 120 of System 100 is virtualized or “sliced” to allow multiple virtual machines access to the same physical hardware while maintaining access control. This virtualization may be implemented using Scalable IOV (SIOV), Single Root I/O Virtualization (SR-IOV) or the like to create virtual device interfaces, while isolating domains, and sharing a device as an Assignable Device Interface (ADI).

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

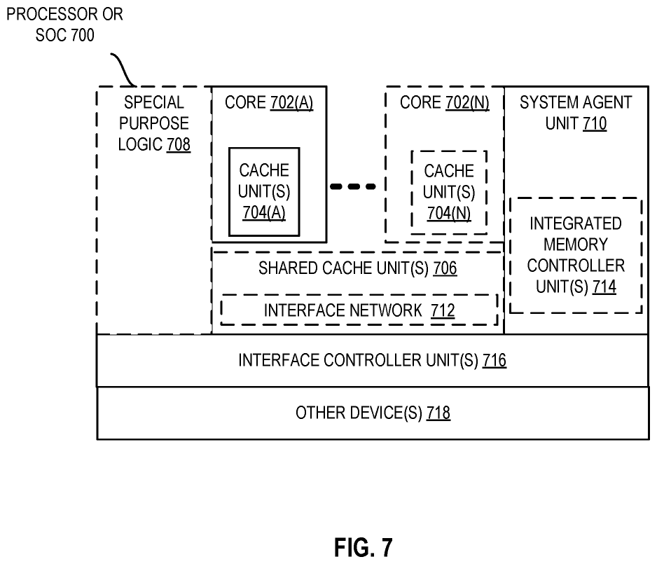

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or coprocessor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

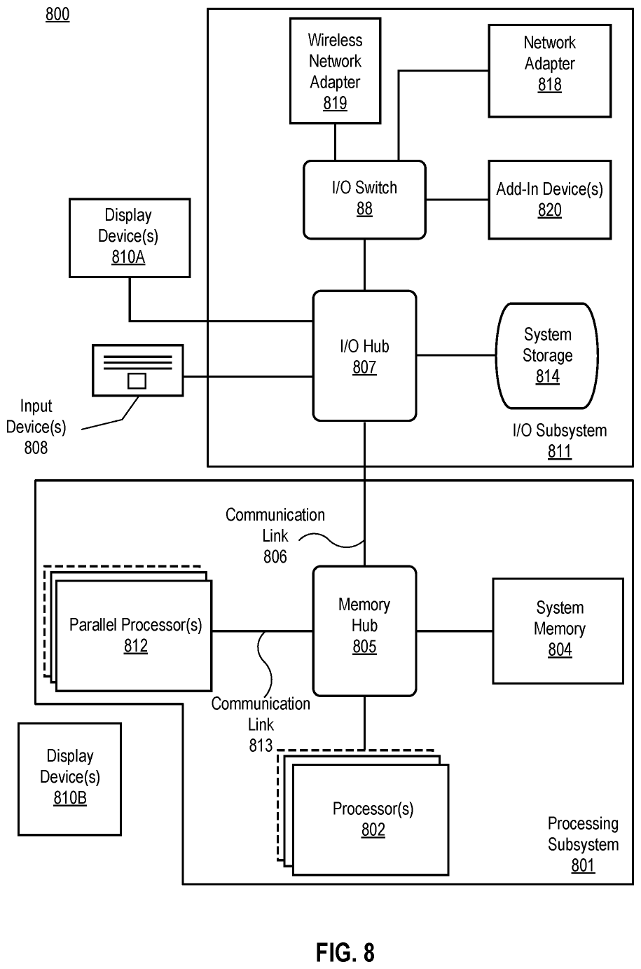

FIG. 8 is a block diagram illustrating a computing system 800 configured to implement one or more aspects of the examples described herein. The computing system 800 includes a processing subsystem 801 having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link 806. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or other communication link 813. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Universal Chiplet Interconnect Express (UCIe), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8. For example, the memory hub 805 may be referred to as a Northbridge in some architectures, while the I/O hub 807 may be referred to as a Southbridge.

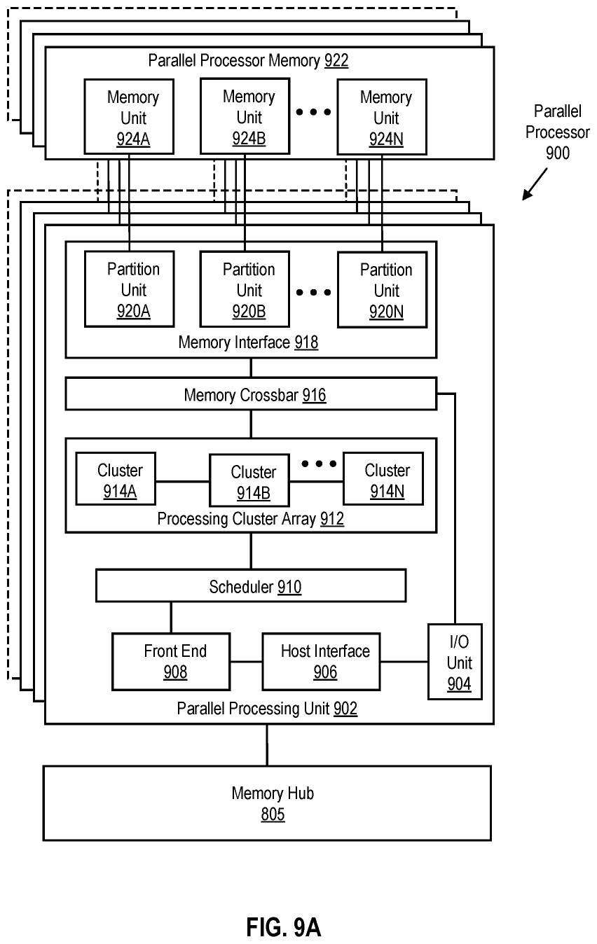

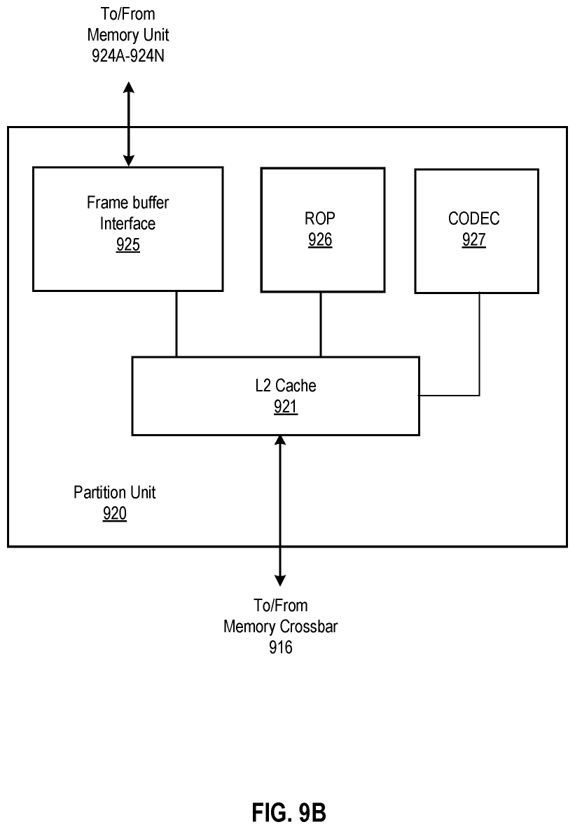

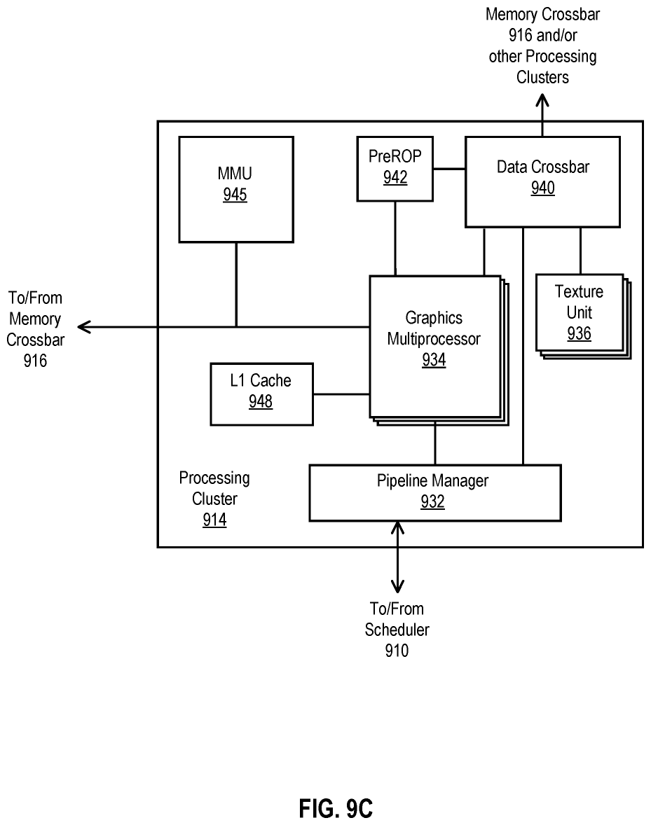

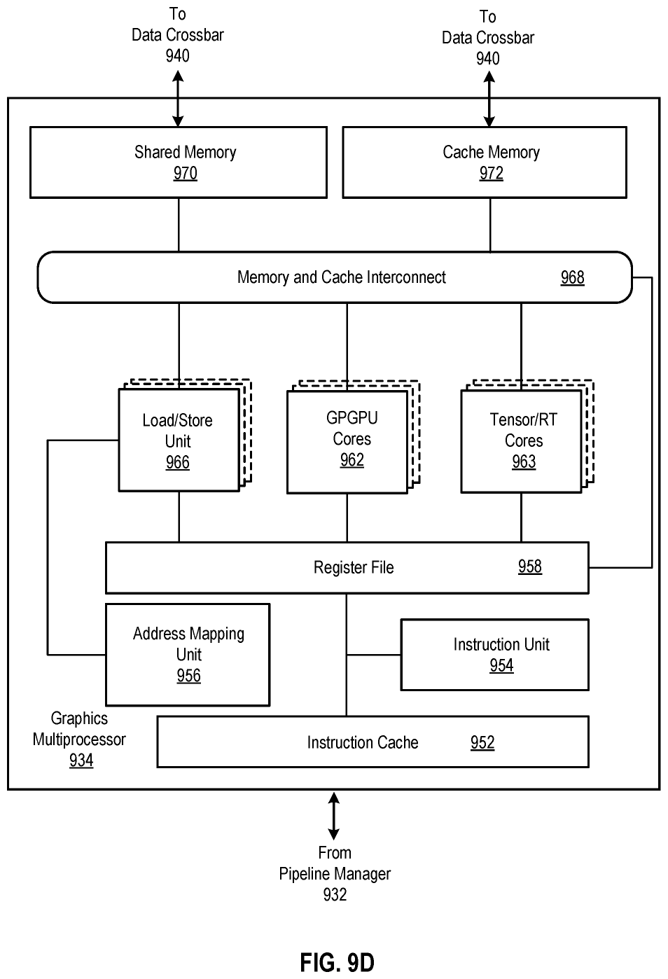

FIG. 9A illustrates examples of a parallel processor 900. The parallel processor 900 may be a GPU, GPGPU or the like as described herein. The various components of the parallel processor 900 may be implemented using one or more integrated circuit devices, such as programmable processors, application specific integrated circuits (ASICs), or field programmable gate arrays (FPGA). The illustrated parallel processor 900 may be one or more of the parallel processor(s) 812 shown in FIG. 8.

The parallel processor 900 includes a parallel processing unit 902. The parallel processing unit includes an I/O unit 904 that enables communication with other devices, including other instances of the parallel processing unit 902. The I/O unit 904 may be directly connected to other devices. For instance, the I/O unit 904 connects with other devices via the use of a hub or switch interface, such as memory hub 805. The connections between the memory hub 805 and the I/O unit 904 form a communication link 813. Within the parallel processing unit 902, the I/O unit 904 connects with a host interface 906 and a memory crossbar 916, where the host interface 906 receives commands directed to performing processing operations and the memory crossbar 916 receives commands directed to performing memory operations.

When the host interface 906 receives a command buffer via the I/O unit 904, the host interface 906 can direct work operations to perform those commands to a front end 908. In some examples the front end 908 couples with a scheduler 910, which is configured to distribute commands or other work items to a processing cluster array 912. The scheduler 910 ensures that the processing cluster array 912 is properly configured and in a valid state before tasks are distributed to the processing clusters of the processing cluster array 912. The scheduler 910 may be implemented via firmware logic executing on a microcontroller. The microcontroller implemented scheduler 910 is configurable to perform complex scheduling and work distribution operations at coarse and fine granularity, enabling rapid preemption and context switching of threads executing on the processing cluster array 912. Preferably, the host software can prove workloads for scheduling on the processing cluster array 912 via one of multiple graphics processing doorbells. In other examples, polling for new workloads or interrupts can be used to identify or indicate availability of work to perform. The workloads can then be automatically distributed across the processing cluster array 912 by the scheduler 910 logic within the scheduler microcontroller.

The processing cluster array 912 can include up to “N” processing clusters (e.g., cluster 914A, cluster 914B, through cluster 914N). Each cluster 914A-914N of the processing cluster array 912 can execute a large number of concurrent threads. The scheduler 910 can allocate work to the clusters 914A-914N of the processing cluster array 912 using various scheduling and/or work distribution algorithms, which may vary depending on the workload arising for each type of program or computation. The scheduling can be handled dynamically by the scheduler 910 or can be assisted in part by compiler logic during compilation of program logic configured for execution by the processing cluster array 912. Optionally, different clusters 914A-914N of the processing cluster array 912 can be allocated for processing different types of programs or for performing different types of computations.

The processing cluster array 912 can be configured to perform various types of parallel processing operations. For example, the processing cluster array 912 is configured to perform general-purpose parallel compute operations. For example, the processing cluster array 912 can include logic to execute processing tasks including filtering of video and/or audio data, performing modeling operations, including physics operations, and performing data transformations.

The processing cluster array 912 is configured to perform parallel graphics processing operations. In such examples in which the parallel processor 900 is configured to perform graphics processing operations, the processing cluster array 912 can include additional logic to support the execution of such graphics processing operations, including, but not limited to texture sampling logic to perform texture operations, as well as tessellation logic and other vertex processing logic. Additionally, the processing cluster array 912 can be configured to execute graphics processing related shader programs such as, but not limited to vertex shaders, tessellation shaders, geometry shaders, and pixel shaders. The parallel processing unit 902 can transfer data from system memory via the I/O unit 904 for processing. During processing the transferred data can be stored to on-chip memory (e.g., parallel processor memory 922) during processing, then written back to system memory.

In examples in which the parallel processing unit 902 is used to perform graphics processing, the scheduler 910 may be configured to divide the processing workload into approximately equal sized tasks, to better enable distribution of the graphics processing operations to multiple clusters 914A-914N of the processing cluster array 912. In some of these examples, portions of the processing cluster array 912 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 914A-914N may be stored in buffers to allow the intermediate data to be transmitted between clusters 914A-914N for further processing.

During operation, the processing cluster array 912 can receive processing tasks to be executed via scheduler 910, which receives commands defining processing tasks from front end 908. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 910 may be configured to fetch the indices corresponding to the tasks or may receive the indices from the front end 908. The front end 908 can be configured to ensure the processing cluster array 912 is configured to a valid state before the workload specified by incoming command buffers (e.g., batch-buffers, push buffers, etc.) is initiated.

Each of the one or more instances of the parallel processing unit 902 can couple with parallel processor memory 922. The parallel processor memory 922 can be accessed via the memory crossbar 916, which can receive memory requests from the processing cluster array 912 as well as the I/O unit 904. The memory crossbar 916 can access the parallel processor memory 922 via a memory interface 918. The memory interface 918 can include multiple partition units (e.g., partition unit 920A, partition unit 920B, through partition unit 920N) that can each couple to a portion (e.g., memory unit) of parallel processor memory 922. The number of partition units 920A-920N may be configured to be equal to the number of memory units, such that a first partition unit 920A has a corresponding first memory unit 924A, a second partition unit 920B has a corresponding second memory unit 924B, and an Nth partition unit 920N has a corresponding Nth memory unit 924N. In other examples, the number of partition units 920A-920N may not be equal to the number of memory devices.

The memory units 924A-924N can include various types of memory devices, including dynamic random-access memory (DRAM) or graphics random access memory, such as synchronous graphics random access memory (SGRAM), including graphics double data rate (GDDR) memory. Optionally, the memory units 924A-924N may also include 3D stacked memory, including but not limited to high bandwidth memory (HBM). Persons skilled in the art will appreciate that the specific implementation of the memory units 924A-924N can vary and can be selected from one of various conventional designs. Render targets, such as frame buffers or texture maps may be stored across the memory units 924A-924N, allowing partition units 920A-920N to write portions of each render target in parallel to efficiently use the available bandwidth of parallel processor memory 922. In some examples, a local instance of the parallel processor memory 922 may be excluded in favor of a unified memory design that utilizes system memory in conjunction with local cache memory.

Optionally, any one of the clusters 914A-914N of the processing cluster array 912 has the ability to process data that will be written to any of the memory units 924A-924N within parallel processor memory 922. The memory crossbar 916 can be configured to transfer the output of each cluster 914A-914N to any partition unit 920A-920N or to another cluster 914A-914N, which can perform additional processing operations on the output. Each cluster 914A-914N can communicate with the memory interface 918 through the memory crossbar 916 to read from or write to various external memory devices. In one of the examples with the memory crossbar 916 the memory crossbar 916 has a connection to the memory interface 918 to communicate with the I/O unit 904, as well as a connection to a local instance of the parallel processor memory 922, enabling the processing units within the different processing clusters 914A-914N to communicate with system memory or other memory that is not local to the parallel processing unit 902. Generally, the memory crossbar 916 may, for example, be able to use virtual channels to separate traffic streams between the clusters 914A-914N and the partition units 920A-920N.

While a single instance of the parallel processing unit 902 is illustrated within the parallel processor 900, any number of instances of the parallel processing unit 902 can be included. For example, multiple instances of the parallel processing unit 902 can be provided on a single add-in card, or multiple add-in cards can be interconnected. For example, the parallel processor 900 can be an add-in device, such as add-in device 820 of FIG. 8, which may be a graphics card such as a discrete graphics card that includes one or more GPUs, one or more memory devices, and device-to-device or network or fabric interfaces. The different instances of the parallel processing unit 902 can be configured to inter-operate even if the different instances have different numbers of processing cores, different amounts of local parallel processor memory, and/or other configuration differences. Optionally, some instances of the parallel processing unit 902 can include higher precision floating point units relative to other instances. Systems incorporating one or more instances of the parallel processing unit 902 or the parallel processor 900 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 902 can be partitioned into multiple instances. Those multiple instances can be configured to execute workloads associated with different clients in an isolated manner, enabling a pre-determined quality of service to be provided for each client. For example, each cluster 914A-914N can be compartmentalized and isolated from other clusters, allowing the processing cluster array 912 to be divided into multiple compute partitions or instances. In such configuration, workloads that execute on an isolated partition are protected from faults or errors associated with a different workload that executes on a different partition. The partition units 920A-920N can be configured to enable a dedicated and/or isolated path to memory for the clusters 914A-914N associated with the respective compute partitions. This datapath isolation enables the compute resources within a partition can communicate with one or more assigned memory units 924A-924N without being subjected to inference by the activities of other partitions.

FIG. 9B is a block diagram of a partition unit 920. The partition unit 920 may be an instance of one of the partition units 920A-920N of FIG. 9A. As illustrated, the partition unit 920 includes an L2 cache 921, a frame buffer interface 925, and a ROP 926 (raster operations unit). The L2 cache 921 is a read/write cache that is configured to perform load and store operations received from the memory crossbar 916 and ROP 926. Read misses and urgent write-back requests are output by L2 cache 921 to frame buffer interface 925 for processing. Updates can also be sent to the frame buffer via frame buffer interface 925 for processing. In some examples the frame buffer interface 925 interfaces with one of the memory units in parallel processor memory, such as the memory units 924A-924N of FIG. 9A (e.g., within parallel processor memory 922). The partition unit 920 may additionally or alternatively also interface with one of the memory units in parallel processor memory via a memory controller (not shown).

In graphics applications, the ROP 926 is a processing unit that performs raster operations such as stencil, z test, blending, and the like. ROP 926 then outputs processed graphics data that is stored in graphics memory. In some examples the ROP 926 includes or couples with a CODEC 927 that includes compression logic to compress depth or color data that is written to memory or the L2 cache 921 and decompress depth or color data that is read from memory or the L2 cache 921. Compression logic can be lossless compression logic that makes use of one or more of multiple compression algorithms. The type of compression that is performed by CODEC 927 can vary based on the statistical characteristics of the data to be compressed. For example, in some examples, delta color compression is performed on depth and color data on a per-tile basis. In some examples, CODEC 927 includes compression and decompression logic that can compress and decompress compute data associated with machine learning operations. CODEC 927 can, for example, compress sparse matrix data for sparse machine learning operations. CODEC 927 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

ROP 926 may be included within each processing cluster (e.g., cluster 914A-914N of FIG. 9A) instead of within the partition unit 920. In such an example, read and write requests for pixel data are transmitted over the memory crossbar 916 instead of pixel fragment data. The processed graphics data may be displayed on a display device, such as one of the one or more display device(s) 810A-810B of FIG. 8, routed for further processing by the processor(s) 802, or routed for further processing by one of the processing entities within the parallel processor 900 of FIG. 9A.

FIG. 9C is a block diagram of a processing cluster 914 within a parallel processing unit. For example, the processing cluster is an instance of one of the processing clusters 914A-914N of FIG. 9A. The processing cluster 914 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to follow divergent execution paths more readily through a given thread program. Persons skilled in the art will understand that a SIMD processing regime represents a functional subset of a SIMT processing regime.

Operation of the processing cluster 914 can be controlled via a pipeline manager 932 that distributes processing tasks to SIMT parallel processors. The pipeline manager 932 receives instructions from scheduler 910 of FIG. 9A and manages execution of those instructions via a graphics multiprocessor 934 and/or a texture unit 936. The illustrated graphics multiprocessor 934 is an exemplary instance of a SIMT parallel processor. However, various types of SIMT parallel processors of differing architectures may be included within the processing cluster 914. One or more instances of the graphics multiprocessor 934 can be included within a processing cluster 914. The graphics multiprocessor 934 can process data and a data crossbar 940 can be used to distribute the processed data to one of multiple possible destinations, including other shader units. The pipeline manager 932 can facilitate the distribution of processed data by specifying destinations for processed data to be distributed via the data crossbar 940.

Each graphics multiprocessor 934 within the processing cluster 914 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 914 constitute a thread. A set of threads executing across the set of parallel processing engines is a thread group. A thread group executes the same program on different input data. Each thread within a thread group can be assigned to a different processing engine within a graphics multiprocessor 934. A thread group may include fewer threads than the number of processing engines within the graphics multiprocessor 934. When a thread group includes fewer threads than the number of processing engines, one or more of the processing engines may be idle during cycles in which that thread group is being processed. A thread group may also include more threads than the number of processing engines within the graphics multiprocessor 934. When the thread group includes more threads than the number of processing engines within the graphics multiprocessor 934, processing can be performed over consecutive clock cycles. Optionally, multiple thread groups can be executed concurrently on graphics multiprocessor 934.

The graphics multiprocessor 934 may include an internal cache memory to perform load and store operations. Optionally, the graphics multiprocessor 934 can forego an internal cache and use a cache memory (e.g., level 1 (L1) cache 948) within the processing cluster 914. Each graphics multiprocessor 934 also has access to level 2 (L2) caches within the partition units (e.g., partition units 920A-920N of FIG. 9A) that are shared among all processing clusters 914 and may be used to transfer data between threads. The graphics multiprocessor 934 may also access off-chip global memory, which can include one or more of local parallel processor memory and/or system memory. Any memory external to the parallel processing unit 902 may be used as global memory. Embodiments in which the processing cluster 914 includes multiple instances of the graphics multiprocessor 934 can share common instructions and data, which may be stored in the L1 cache 948.

Each processing cluster 914 may include an MMU 945 (memory management unit) that is configured to map virtual addresses into physical addresses. In other examples, one or more instances of the MMU 945 may reside within the memory interface 918 of FIG. 9A. The MMU 945 includes a set of page table entries (PTEs) used to map a virtual address to a physical address of a tile and optionally a cache line index. The MMU 945 may include address translation lookaside buffers (TLB) or caches that may reside within the graphics multiprocessor 934 or the L1 cache 948 of processing cluster 914. The physical address is processed to distribute surface data access locality to allow efficient request interleaving among partition units. The cache line index may be used to determine whether a request for a cache line is a hit or miss.

In graphics and computing applications, a processing cluster 914 may be configured such that each graphics multiprocessor 934 is coupled to a texture unit 936 for performing texture mapping operations, e.g., determining texture sample positions, reading texture data, and filtering the texture data. Texture data is read from an internal texture L1 cache (not shown) or in some examples from the L1 cache within graphics multiprocessor 934 and is fetched from an L2 cache, local parallel processor memory, or system memory, as needed. Each graphics multiprocessor 934 outputs processed tasks to the data crossbar 940 to provide the processed task to another processing cluster 914 for further processing or to store the processed task in an L2 cache, local parallel processor memory, or system memory via the memory crossbar 916. A preROP 942 (pre-raster operations unit) is configured to receive data from graphics multiprocessor 934, direct data to ROP units, which may be located with partition units as described herein (e.g., partition units 920A-920N of FIG. 9A). The preROP 942 unit can perform optimizations for color blending, organize pixel color data, and perform address translations.

It will be appreciated that the core architecture described herein is illustrative and that variations and modifications are possible. Any number of processing units, e.g., graphics multiprocessor 934, texture units 936, preROPs 942, etc., may be included within a processing cluster 914. Further, while only one processing cluster 914 is shown, a parallel processing unit as described herein may include any number of instances of the processing cluster 914. Optionally, each processing cluster 914 can be configured to operate independently of other processing clusters 914 using separate and distinct processing units, L1 caches, L2 caches, etc.

FIG. 9D shows an example of graphics multiprocessor 934 in which the graphics multiprocessor 934 couples with the pipeline manager 932 of the processing cluster 914. The graphics multiprocessor 934 has an execution pipeline including but not limited to an instruction cache 952, an instruction unit 954, an address mapping unit 956, a register file 958, one or more general purpose graphics processing unit (GPGPU) cores 962, and one or more load/store units 966. The GPGPU cores 962 and load/store units 966 are coupled with cache memory 972 and shared memory 970 via a memory and cache interconnect 968. The graphics multiprocessor 934 may additionally include tensor and/or ray-tracing cores 963 that include hardware logic to accelerate matrix and/or ray-tracing operations.

The instruction cache 952 may receive a stream of instructions to execute from the pipeline manager 932. The instructions are cached in the instruction cache 952 and dispatched for execution by the instruction unit 954. The instruction unit 954 can dispatch instructions as thread groups (e.g., warps), with each thread of the thread group assigned to a different execution unit within GPGPU core 962. An instruction can access any of a local, shared, or global address space by specifying an address within a unified address space. The address mapping unit 956 can be used to translate addresses in the unified address space into a distinct memory address that can be accessed by the load/store units 966.

The register file 958 provides a set of registers for the functional units of the graphics multiprocessor 934. The register file 958 provides temporary storage for operands connected to the data paths of the functional units (e.g., GPGPU cores 962, load/store units 966) of the graphics multiprocessor 934. The register file 958 may be divided between each of the functional units such that each functional unit is allocated a dedicated portion of the register file 958. For example, the register file 958 may be divided between the different warps being executed by the graphics multiprocessor 934.

The GPGPU cores 962 can each include floating point units (FPUs) and/or integer arithmetic logic units (ALUs) that are used to execute instructions of the graphics multiprocessor 934. In some implementations, the GPGPU cores 962 can include hardware logic that may otherwise reside within the tensor and/or ray-tracing cores 963. The GPGPU cores 962 can be similar in architecture or can differ in architecture. For example and in some examples, a first portion of the GPGPU cores 962 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 934 can additionally include one or more fixed function or special function units to perform specific functions such as copy rectangle or pixel blending operations. One or more of the GPGPU cores can also include fixed or special function logic.

The GPGPU cores 962 may include SIMD logic capable of performing a single instruction on multiple sets of data. Optionally, GPGPU cores 962 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 968 is an interconnect network that connects each of the functional units of the graphics multiprocessor 934 to the register file 958 and to the shared memory 970. For example, the memory and cache interconnect 968 is a crossbar interconnect that allows the load/store unit 966 to implement load and store operations between the shared memory 970 and the register file 958. The register file 958 can operate at the same frequency as the GPGPU cores 962, thus data transfer between the GPGPU cores 962 and the register file 958 is very low latency. The shared memory 970 can be used to enable communication between threads that execute on the functional units within the graphics multiprocessor 934. The cache memory 972 can be used as a data cache for example, to cache texture data communicated between the functional units and the texture unit 936. The shared memory 970 can also be used as a program managed cached. The shared memory 970 and the cache memory 972 can couple with the data crossbar 940 to enable communication with other components of the processing cluster. Threads executing on the GPGPU cores 962 can programmatically store data within the shared memory in addition to the automatically cached data that is stored within the cache memory 972.

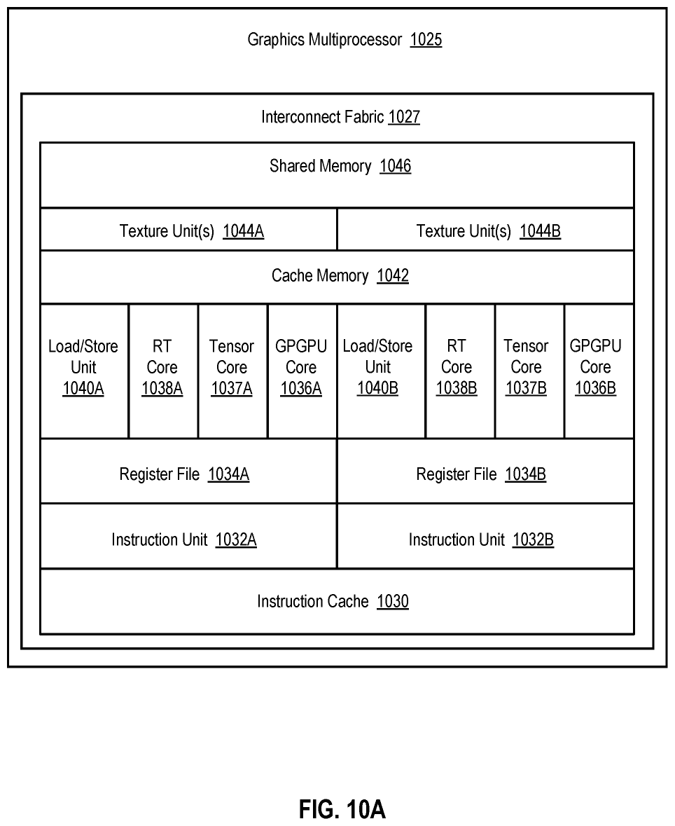

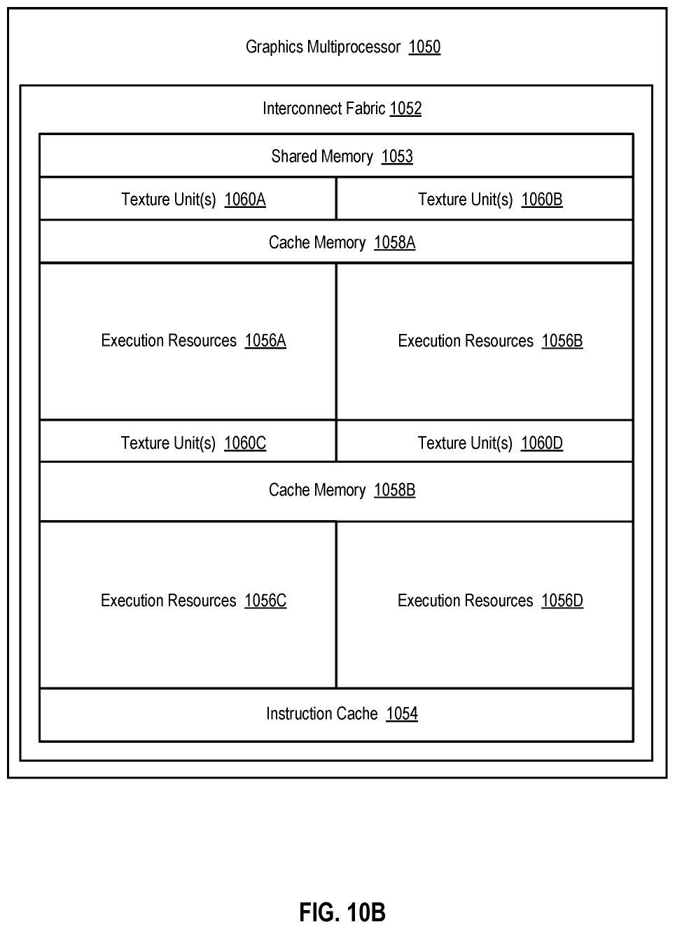

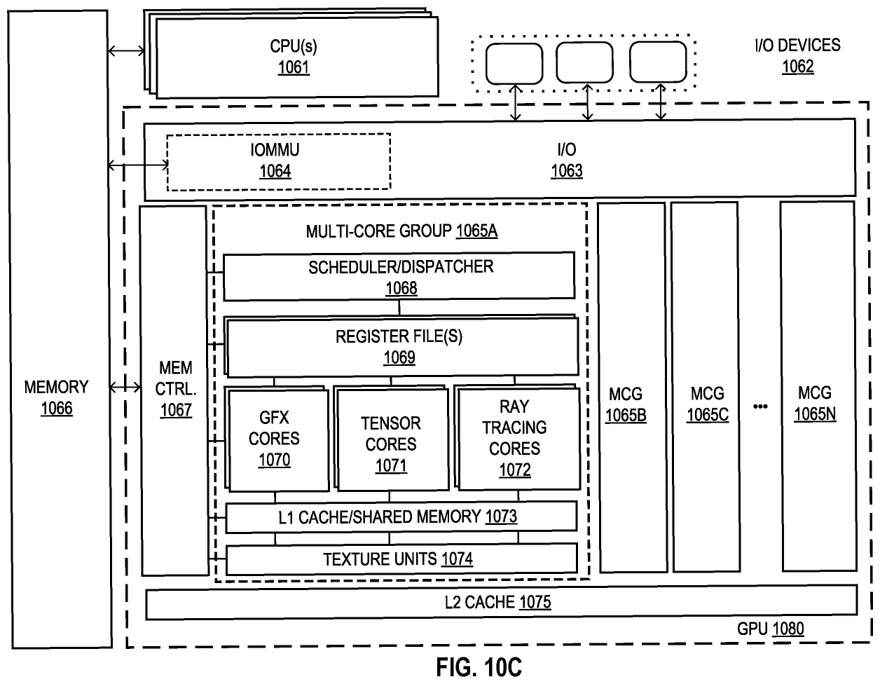

FIGS. 10A-10C illustrate additional graphics multiprocessors, according to examples. FIG. 10A-10B illustrate graphics multiprocessors 1025, 1050, which are related to the graphics multiprocessor 934 of FIG. 9C and may be used in place of one of those. Therefore, the disclosure of any features in combination with the graphics multiprocessor 934 herein also discloses a corresponding combination with the graphics multiprocessor(s) 1025, 1050, but is not limited to such. FIG. 10C illustrates a graphics processing unit (GPU) 1080 which includes dedicated sets of graphics processing resources arranged into multi-core groups 1065A-1065N, which correspond to the graphics multiprocessors 1025, 1050. The illustrated graphics multiprocessors 1025, 1050 and the multi-core groups 1065A-1065N can be streaming multiprocessors (SM) capable of simultaneous execution of a large number of execution threads.

The graphics multiprocessor 1025 of FIG. 10A includes multiple additional instances of execution resource units relative to the graphics multiprocessor 934 of FIG. 9D. For example, the graphics multiprocessor 1025 can include multiple instances of the instruction unit 1032A-1032B, register file 1034A-1034B, and texture unit(s) 1044A-1044B. The graphics multiprocessor 1025 also includes multiple sets of graphics or compute execution units (e.g., GPGPU core 1036A-1036B, tensor core 1037A-1037B, ray-tracing core 1038A-1038B) and multiple sets of load/store units 1040A-1040B. The execution resource units have a common instruction cache 1030, texture and/or data cache memory 1042, and shared memory 1046.

The various components can communicate via an interconnect fabric 1027. The interconnect fabric 1027 may include one or more crossbar switches to enable communication between the various components of the graphics multiprocessor 1025. The interconnect fabric 1027 may be a separate, high-speed network fabric layer upon which each component of the graphics multiprocessor 1025 is stacked. The components of the graphics multiprocessor 1025 communicate with remote components via the interconnect fabric 1027. For example, the cores 1036A-1036B, 1037A-1037B, and 1038A-1038B can each communicate with shared memory 1046 via the interconnect fabric 1027. The interconnect fabric 1027 can arbitrate communication within the graphics multiprocessor 1025 to ensure a fair bandwidth allocation between components.

The graphics multiprocessor 1050 of FIG. 10B includes multiple sets of execution resources 1056A-1056D, where each set of execution resource includes multiple instruction units, register files, GPGPU cores, and load store units, as illustrated in FIG. 9D and FIG. 10A. The execution resources 1056A-1056D can work in concert with texture unit(s) 1060A-1060D for texture operations, while sharing an instruction cache 1054, and shared memory 1053. For example, the execution resources 1056A-1056D can share an instruction cache 1054 and shared memory 1053, as well as multiple instances of a texture and/or data cache memory 1058A-1058B. The various components can communicate via an interconnect fabric 1052 similar to the interconnect fabric 1027 of FIG. 10A.

Persons skilled in the art will understand that the architecture described in FIGS. 1, 9A-9D, and 10A-10B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 902 of FIG. 9A, as well as one or more graphics processors or special purpose processing units, without departure from the scope of the examples described herein.

The parallel processor or GPGPU as described herein maybe communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 10C illustrates a graphics processing unit (GPU) 1080 which includes dedicated sets of graphics processing resources arranged into multi-core groups 1065A-1065N. While the details of only a single multi-core group 1065A are provided, it will be appreciated that the other multi-core groups 1065B-1065N may be equipped with the same or similar sets of graphics processing resources. Details described with respect to the multi-core groups 1065A-1065N may also apply to any graphics multiprocessor 934, 1025, 1050 described herein.

As illustrated, a multi-core group 1065A may include a set of graphics cores 1070, a set of tensor cores 1071, and a set of ray tracing cores 1072. A scheduler/dispatcher 1068 schedules and dispatches the graphics threads for execution on the various cores 1070, 1071, 1072. A set of register files 1069 store operand values used by the cores 1070, 1071, 1072 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1073 store graphics data such as texture data, vertex data, pixel data, ray data, bounding volume data, etc., locally within each multi-core group 1065A. One or more texture units 1074 can also be used to perform texturing operations, such as texture mapping and sampling. A Level 2 (L2) cache 1075 shared by all or a subset of the multi-core groups 1065A-1065N stores graphics data and/or instructions for multiple concurrent graphics threads. As illustrated, the L2 cache 1075 may be shared across a plurality of multi-core groups 1065A-1065N. One or more memory controllers 1067 couple the GPU 1080 to a memory 1066 which may be a system memory (e.g., DRAM) and/or a dedicated graphics memory (e.g., GDDR6 memory).

Input/output (I/O) circuitry 1063 couples the GPU 1080 to one or more I/O devices 1062 such as digital signal processors (DSPs), network controllers, or user input devices. An on-chip interconnect may be used to couple the I/O devices 1062 to the GPU 1080 and memory 1066. One or more I/O memory management units (IOMMUs) 1064 of the I/O circuitry 1063 couple the I/O devices 1062 directly to the system memory 1066. Optionally, the IOMMU 1064 manages multiple sets of page tables to map virtual addresses to physical addresses in system memory 1066. The I/O devices 1062, CPU(s) 1061, and GPU(s) 1080 may then share the same virtual address space.

In one implementation of the IOMMU 1064, the IOMMU 1064 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1066). The base addresses of each of the first and second sets of page tables may be stored in control registers and swapped out on a context switch (e.g., so that the new context is provided with access to the relevant set of page tables). While not illustrated in FIG. 10C, each of the cores 1070, 1071, 1072 and/or multi-core groups 1065A-1065N may include translation lookaside buffers (TLBs) to cache guest virtual to guest physical translations, guest physical to host physical translations, and guest virtual to host physical translations.

The CPU(s) 1061, GPUs 1080, and I/O devices 1062 may be integrated on a single semiconductor chip and/or chip package. The illustrated memory 1066 may be integrated on the same chip or may be coupled to the memory controllers 1067 via an off-chip interface. In one implementation, the memory 1066 comprises GDDR6 memory which shares the same virtual address space as other physical system-level memories, although the underlying principles described herein are not limited to this specific implementation.

The tensor cores 1071 may include a plurality of execution units specifically designed to perform matrix operations, which are the fundamental compute operation used to perform deep learning operations. For example, simultaneous matrix multiplication operations may be used for neural network training and inferencing. The tensor cores 1071 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1071. The training of neural networks, in particular, requires a significant number of matrix dot product operations. In order to process an inner-product formulation of an N×N×N matrix multiply, the tensor cores 1071 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1071 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1071 support a sparse mode of operation for matrices in which the vast majority of values are zero. The tensor cores 1071 include support for sparse input matrices that are encoded in a sparse matrix representation (e.g., coordinate list encoding (COO), compressed sparse row (CSR), compress sparse column (CSC), etc.). The tensor cores 1071 also include support for compressed sparse matrix representations in the event that the sparse matrix representation may be further compressed. Compressed, encoded, and/or compressed and encoded matrix data, along with associated compression and/or encoding metadata, can be read by the tensor cores 1071 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1071, output matrix C may be output in a compressed format, a sparse encoding, or a compressed sparse encoding.

The ray tracing cores 1072 may accelerate ray tracing operations for both real-time ray tracing and non-real-time ray tracing implementations. In particular, the ray tracing cores 1072 may include ray traversal/intersection circuitry for performing ray traversal using bounding volume hierarchies (BVHs) and identifying intersections between rays and primitives enclosed within the BVH volumes. The ray tracing cores 1072 may also include circuitry for performing depth testing and culling (e.g., using a Z buffer or similar arrangement). In one implementation, the ray tracing cores 1072 perform traversal and intersection operations in concert with the image denoising techniques described herein, at least a portion of which may be executed on the tensor cores 1071. For example, the tensor cores 1071 may implement a deep learning neural network to perform denoising of frames generated by the ray tracing cores 1072. However, the CPU(s) 1061, graphics cores 1070, and/or ray tracing cores 1072 may also implement all or a portion of the denoising and/or deep learning algorithms.

In addition, as described above, a distributed approach to denoising may be employed in which the GPU 1080 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1072 may process all BVH traversal and/or ray-primitive intersections, saving the graphics cores 1070 from being overloaded with thousands of instructions per ray. For example, each ray tracing core 1072 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1065A can simply launch a ray probe, and the ray tracing cores 1072 independently perform ray traversal and intersection and return hit data (e.g., a hit, no hit, multiple hits, etc.) to the thread context. The other cores 1070, 1071 are freed to perform other graphics or compute work while the ray tracing cores 1072 perform the traversal and intersection operations.

Optionally, each ray tracing core 1072 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1070 and tensor cores 1071) are freed to perform other forms of graphics work.

In some examples described below, a hybrid rasterization/ray tracing approach is used in which work is distributed between the graphics cores 1070 and ray tracing cores 1072.

The ray tracing cores 1072 (and/or other cores 1070, 1071) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1072, graphics cores 1070 and tensor cores 1071 is Vulkan API (e.g., Vulkan version 1.1.85 and later). Note, however, that the underlying principles described herein are not limited to any particular ray tracing ISA.

In general, the various cores 1072, 1071, 1070 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1072 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1072 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1072 can also be used to perform computations that are not directly analogous to ray tracing. For example, mesh projection, mesh refinement, and volume sampling computations can be accelerated using the ray tracing cores 1072. Generic coordinate space calculations, such as nearest neighbor calculations can also be performed. For example, the set of points near a given point can be discovered by defining a bounding box in the coordinate space around the point. BVH and ray probe logic within the ray tracing cores 1072 can then be used to determine the set of point intersections within the bounding box. The intersections constitute the origin point and the nearest neighbors to that origin point. Computations that are performed using the ray tracing cores 1072 can be performed in parallel with computations performed on the graphics cores 1072 and tensor cores 1071. A shader compiler can be configured to compile a compute shader or other general-purpose graphics processing program into low level primitives that can be parallelized across the graphics cores 1070, tensor cores 1071, and ray tracing cores 1072.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

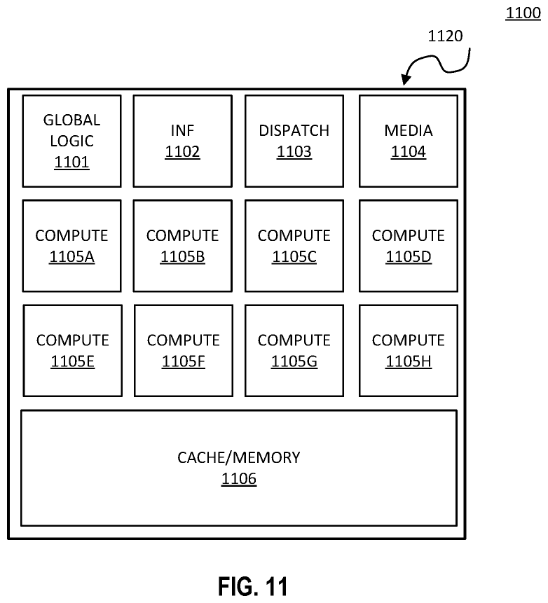

FIG. 11 shows a parallel computing system 1100, according to some examples. In some examples the parallel computing system 1100 includes a parallel processor 1120, which can be a graphics processor or compute accelerator as described herein. The parallel processor 1120 includes a global logic unit 1101, an interface 1102, a thread dispatcher 1103, a media unit 1104, a set of compute units 1105A-1105H, and a cache/memory units 1106. The global logic unit 1101, in some examples, includes global functionality for the parallel processor 1120, including device configuration registers, global schedulers, power management logic, and the like. The interface 1102 can include a front-end interface for the parallel processor 1120. The thread dispatcher 1103 can receive workloads from interface 1102 and dispatch threads for the workload to the compute units 1105A-1105H. If the workload includes any media operations, at least a portion of those operations can be performed by the media unit 1104. The media unit can also offload some operations to the compute units 1105A-1105H. The cache/memory units 1106 can include cache memory (e.g., L3 cache) and local memory (e.g., HBM, GDDR) for the parallel processor 1120.

Example Core Architectures—in-Order and Out-of-Order Core Block Diagram.

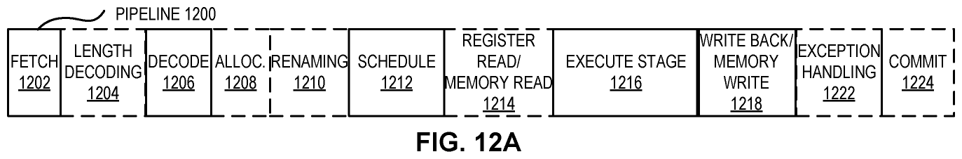

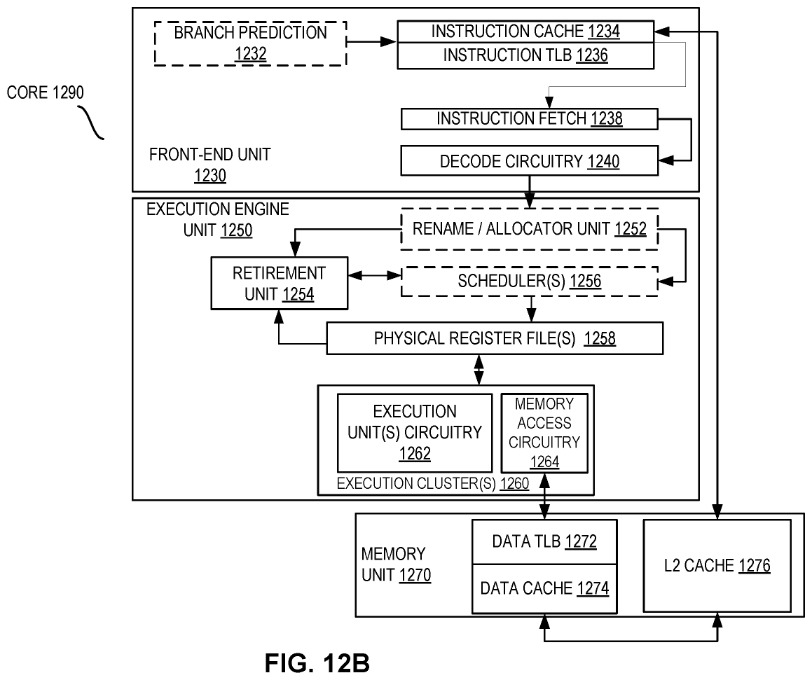

FIG. 12A is a block diagram illustrating both an example in-order pipeline and an example register renaming, out-of-order issue/execution pipeline according to examples. FIG. 12B is a block diagram illustrating both an example in-order architecture core and an example register renaming, out-of-order issue/execution architecture core to be included in a processor according to examples. The solid lined boxes in FIGS. 12A-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12A, a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1206 and the register read/memory read stage 1214 may be combined into one pipeline stage. In some examples, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12B may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12B shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In some examples, the instruction cache circuitry 1234 is included in the memory unit circuitry 1270 rather than the front-end circuitry 1230. The decode circuitry 1240 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1240 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1240 may be implemented using various different mechanisms. Examples of suitable mechanisms include, but are not limited to, look-up tables, hardware implementations, programmable logic arrays (PLAs), microcode read only memories (ROMs), etc. In some examples, the core 1290 includes a microcode ROM (not shown) or other medium that stores microcode for certain macroinstructions (e.g., in decode circuitry 1240 or otherwise within the front-end circuitry 1230). In some examples, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine circuitry 1250.

The execution engine circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In some examples, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270. In some examples, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 1290 includes logic to support a packed data instruction set architecture extension (e.g., AVX1, AVX2), thereby allowing the operations used by many multimedia applications to be performed using packed data.

### Example Execution Unit(s) Circuitry.

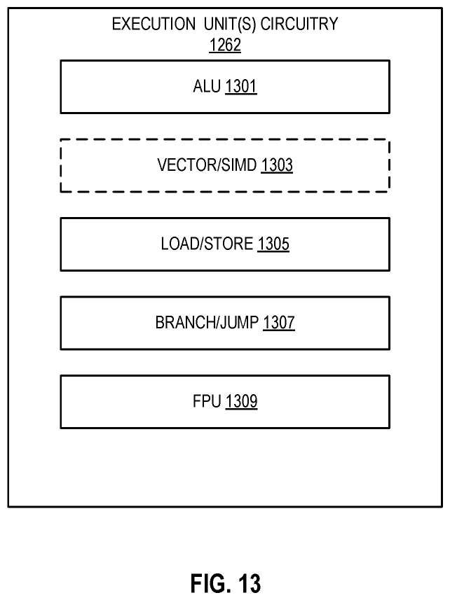

FIG. 13 illustrates examples of execution unit(s) circuitry, such as execution unit(s) circuitry 1262 of FIG. 12B. As illustrated, execution unit(s) circuitry ‘BPH62 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers). Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Graphics Execution Units

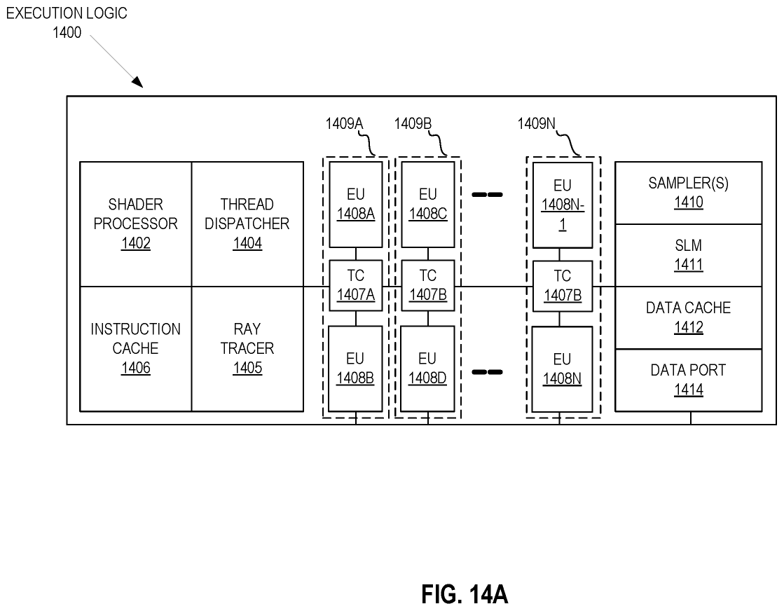

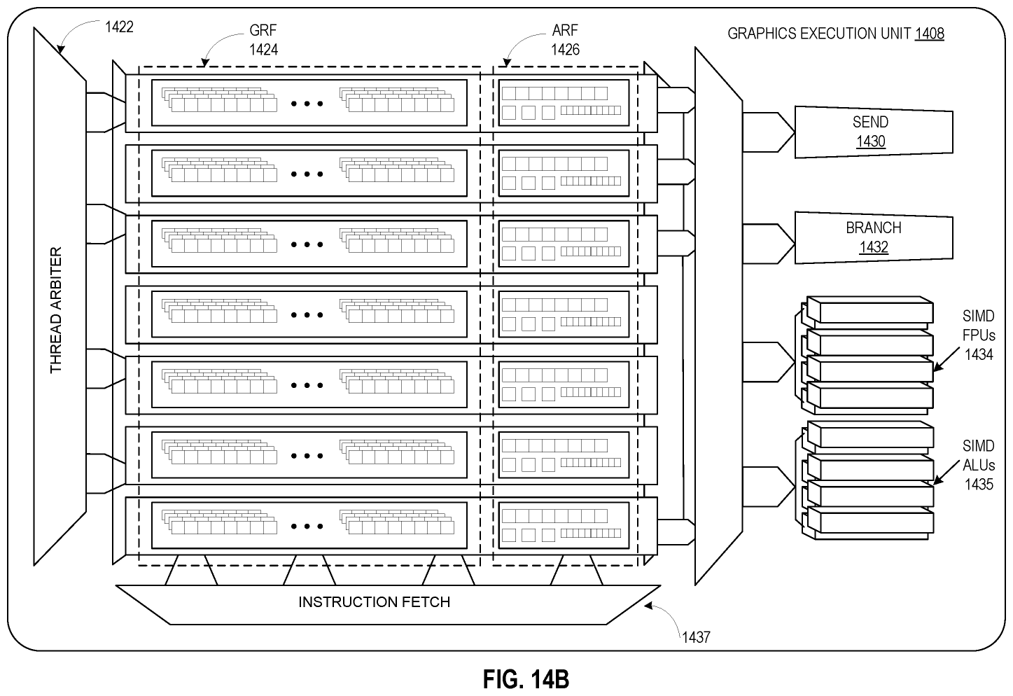

FIGS. 14A-14B illustrate thread execution logic 1400 including an array of processing elements employed in a graphics processor core according to examples described herein. Elements of FIGS. 14A-14B having the same reference numbers (or names) as the elements of any other figure herein can operate or function in any manner similar to that described elsewhere herein, but are not limited to such. FIG. 14A is representative of an execution unit within a general-purpose graphics processor, while FIG. 14B is representative of an execution unit that may be used within a compute accelerator.

As illustrated in FIG. 14A, in some examples thread execution logic 1400 includes a shader processor 1402, a thread dispatcher 1404, instruction cache 1406, a scalable execution unit array including a plurality of execution units 1408A-1408N, a sampler 1410, shared local memory 1411, a data cache 1412, and a data port 1414. In some examples the scalable execution unit array can dynamically scale by enabling or disabling one or more execution units (e.g., any of execution units 1408A, 1408B, 1408C, 1408D, through 1408N-1 and 1408N) based on the computational requirements of a workload. In some examples the included components are interconnected via an interconnect fabric that links to each of the components. In some examples, thread execution logic 1400 includes one or more connections to memory, such as system memory or cache memory, through one or more of instruction cache 1406, data port 1414, sampler 1410, and execution units 1408A-1408N. In some examples, each execution unit (e.g. 1408A) is a stand-alone programmable general-purpose computational unit that is capable of executing multiple simultaneous hardware threads while processing multiple data elements in parallel for each thread. In various examples, the array of execution units 1408A-1408N is scalable to include any number individual execution units.

In some examples, the execution units 1408A-1408N are primarily used to execute shader programs. A shader processor 1402 can process the various shader programs and dispatch execution threads associated with the shader programs via a thread dispatcher 1404. In some examples the thread dispatcher includes logic to arbitrate thread initiation requests from the graphics and media pipelines and instantiate the requested threads on one or more execution unit in the execution units 1408A-1408N. For example, a geometry pipeline can dispatch vertex, tessellation, or geometry shaders to the thread execution logic for processing. In some examples, thread dispatcher 1404 can also process runtime thread spawning requests from the executing shader programs.

In some examples, the execution units 1408A-1408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1408A-1408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1408A-1408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1408A-1408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1408A-1408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 1409A-1409N having thread control logic (1407A-1407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1409A-1409N includes at least two execution units. For example, fused execution unit 1409A includes a first EU 1408A, second EU 1408B, and thread control logic 1407A that is common to the first EU 1408A and the second EU 1408B. The thread control logic 1407A controls threads executed on the fused graphics execution unit 1409A, allowing each EU within the fused execution units 1409A-1409N to execute using a common instruction pointer register.

One or more internal instruction caches (e.g., 1406) are included in the thread execution logic 1400 to cache thread instructions for the execution units. In some examples, one or more data caches (e.g., 1412) are included to cache thread data during thread execution. Threads executing on the execution logic 1400 can also store explicitly managed data in the shared local memory 1411. In some examples, a sampler 1410 is included to provide texture sampling for 3D operations and media sampling for media operations. In some examples, sampler 1410 includes specialized texture or media sampling functionality to process texture or media data during the sampling process before providing the sampled data to an execution unit.

During execution, the graphics and media pipelines send thread initiation requests to thread execution logic 1400 via thread spawning and dispatch logic. Once a group of geometric objects has been processed and rasterized into pixel data, pixel processor logic (e.g., pixel shader logic, fragment shader logic, etc.) within the shader processor 1402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1402 then executes an application programming interface (API)-supplied pixel or fragment shader program. To execute the shader program, the shader processor 1402 dispatches threads to an execution unit (e.g., 1408A) via thread dispatcher 1404. In some examples, shader processor 1402 uses texture sampling logic in the sampler 1410 to access texture data in texture maps stored in memory. Arithmetic operations on the texture data and the input geometry data compute pixel color data for each geometric fragment, or discards one or more pixels from further processing.

In some examples, the data port 1414 provides a memory access mechanism for the thread execution logic 1400 to output processed data to memory for further processing on a graphics processor output pipeline. In some examples, the data port 1414 includes or couples to one or more cache memories (e.g., data cache 1412) to cache data for memory access via the data port.

In some examples, the execution logic 1400 can also include a ray tracer 1405 that can provide ray tracing acceleration functionality. The ray tracer 1405 can support a ray tracing instruction set that includes instructions/functions for ray generation.

FIG. 14B illustrates exemplary internal details of an execution unit 1408, according to examples. A graphics execution unit 1408 can include an instruction fetch unit 1437, a general register file array (GRF) 1424, an architectural register file array (ARF) 1426, a thread arbiter 1422, a send unit 1430, a branch unit 1432, a set of SIMD floating point units (FPUs) 1434, and in some examples a set of dedicated integer SIMD ALUs 1435. The GRF 1424 and ARF 1426 includes the set of general register files and architecture register files associated with each simultaneous hardware thread that may be active in the graphics execution unit 1408. In some examples, per thread architectural state is maintained in the ARF 1426, while data used during thread execution is stored in the GRF 1424. The execution state of each thread, including the instruction pointers for each thread, can be held in thread-specific registers in the ARF 1426.

In some examples the graphics execution unit 1408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1408 is not limited to the number of hardware threads, and multiple logical threads can be assigned to each hardware thread.

In some examples, the graphics execution unit 1408 can co-issue multiple instructions, which may each be different instructions. The thread arbiter 1422 of the graphics execution unit thread 1408 can dispatch the instructions to one of the send unit 1430, branch unit 1432, or SIMD FPU(s) 1434 for execution. Each execution thread can access 128 general-purpose registers within the GRF 1424, where each register can store 32 bytes, accessible as a SIMD 8-element vector of 32-bit data elements. In some examples, each execution unit thread has access to 4 Kbytes within the GRF 1424, although examples are not so limited, and greater or fewer register resources may be provided in other examples. In some examples the graphics execution unit 1408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1424 can store a total of 28 Kbytes. Where 16 threads may access 4 Kbytes, the GRF 1424 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1430. In some examples, branch instructions are dispatched to a dedicated branch unit 1432 to facilitate SIMD divergence and eventual convergence.

In some examples the graphics execution unit 1408 includes one or more SIMD floating point units (FPU(s)) 1434 to perform floating-point operations. In some examples, the FPU(s) 1434 also support integer computation. In some examples the FPU(s) 1434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1435 are also present, and may be specifically optimized to perform operations associated with machine learning computations.

In some examples, arrays of multiple instances of the graphics execution unit 1408 can be instantiated in a graphics sub-core grouping (e.g., a sub-slice). For scalability, product architects can choose the exact number of execution units per sub-core grouping. In some examples the execution unit 1408 can execute instructions across a plurality of execution channels. In a further example, each thread executed on the graphics execution unit 1408 is executed on a different channel.

### Graphics Pipeline

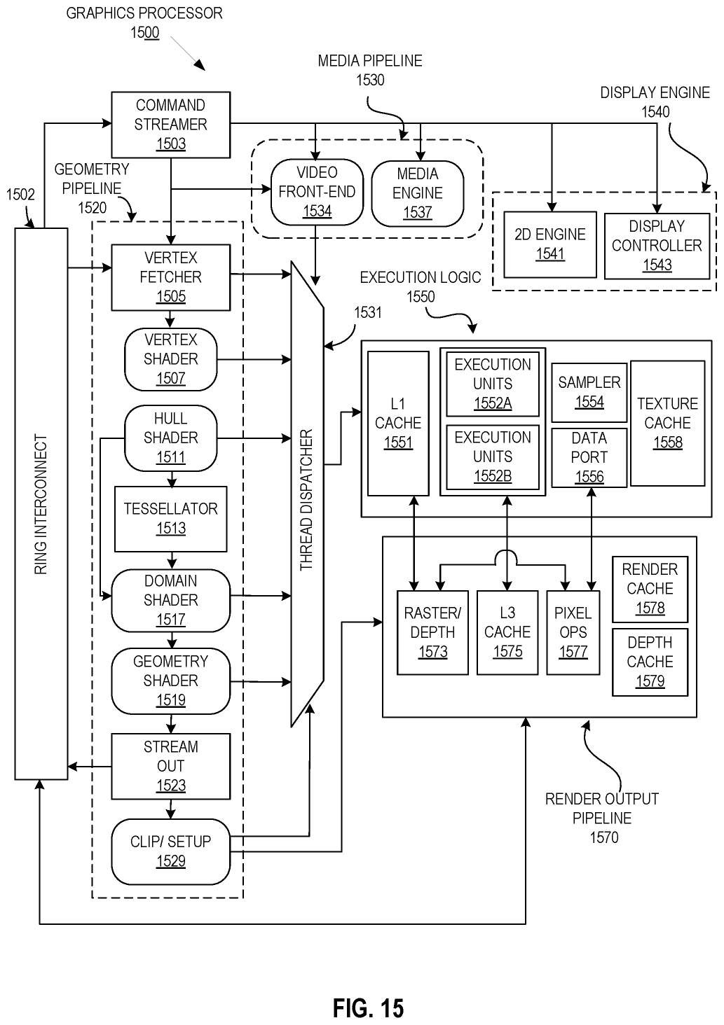

FIG. 15 is a block diagram of another example of a graphics processor 1500. Elements of FIG. 15 having the same reference numbers (or names) as the elements of any other figure herein can operate or function in any manner similar to that described elsewhere herein, but are not limited to such.

In some examples, graphics processor 1500 includes a geometry pipeline 1520, a media pipeline 1530, a display engine 1540, thread execution logic 1550, and a render output pipeline 1570. In some examples, graphics processor 1500 is a graphics processor within a multi-core processing system that includes one or more general-purpose processing cores. The graphics processor is controlled by register writes to one or more control registers (not shown) or via commands issued to graphics processor 1500 via a ring interconnect 1502. In some examples, ring interconnect 1502 couples graphics processor 1500 to other processing components, such as other graphics processors or general-purpose processors. Commands from ring interconnect 1502 are interpreted by a command streamer 1503, which supplies instructions to individual components of the geometry pipeline 1520 or the media pipeline 1530.

In some examples, command streamer 1503 directs the operation of a vertex fetcher 1505 that reads vertex data from memory and executes vertex-processing commands provided by command streamer 1503. In some examples, vertex fetcher 1505 provides vertex data to a vertex shader 1507, which performs coordinate space transformation and lighting operations to each vertex. In some examples, vertex fetcher 1505 and vertex shader 1507 execute vertex-processing instructions by dispatching execution threads to execution units 1552A-1552B via a thread dispatcher 1531.

In some examples, execution units 1552A-1552B are an array of vector processors having an instruction set for performing graphics and media operations. In some examples, execution units 1552A-1552B have an attached L1 cache 1551 that is specific for each array or shared between the arrays. The cache can be configured as a data cache, an instruction cache, or a single cache that is partitioned to contain data and instructions in different partitions.

In some examples, geometry pipeline 1520 includes tessellation components to perform hardware-accelerated tessellation of 3D objects. In some examples, a programmable hull shader 1511 configures the tessellation operations. A programmable domain shader 1517 provides back-end evaluation of tessellation output. A tessellator 1513 operates at the direction of hull shader 1511 and contains special purpose logic to generate a set of detailed geometric objects based on a coarse geometric model that is provided as input to geometry pipeline 1520. In some examples, if tessellation is not used, tessellation components (e.g., hull shader 1511, tessellator 1513, and domain shader 1517) can be bypassed.

In some examples, complete geometric objects can be processed by a geometry shader 1519 via one or more threads dispatched to execution units 1552A-1552B, or can proceed directly to the clipper 1529. In some examples, the geometry shader operates on entire geometric objects, rather than vertices or patches of vertices as in previous stages of the graphics pipeline. If the tessellation is disabled the geometry shader 1519 receives input from the vertex shader 1507. In some examples, geometry shader 1519 is programmable by a geometry shader program to perform geometry tessellation if the tessellation units are disabled.

Before rasterization, a clipper 1529 processes vertex data. The clipper 1529 may be a fixed function clipper or a programmable clipper having clipping and geometry shader functions. In some examples, a rasterizer and depth test component 1573 in the render output pipeline 1570 dispatches pixel shaders to convert the geometric objects into per pixel representations. In some examples, pixel shader logic is included in thread execution logic 1550. In some examples, an application can bypass the rasterizer and depth test component 1573 and access un-rasterized vertex data via a stream out unit 1523.

The graphics processor 1500 has an interconnect bus, interconnect fabric, or some other interconnect mechanism that allows data and message passing amongst the major components of the processor. In some examples, execution units 1552A-1552B and associated logic units (e.g., L1 cache 1551, sampler 1554, texture cache 1558, etc.) interconnect via a data port 1556 to perform memory access and communicate with render output pipeline components of the processor. In some examples, sampler 1554, caches 1551, 1558 and execution units 1552A-1552B each have separate memory access paths. In some examples the texture cache 1558 can also be configured as a sampler cache.

In some examples, render output pipeline 1570 contains a rasterizer and depth test component 1573 that converts vertex-based objects into an associated pixel-based representation. In some examples, the rasterizer logic includes a windower/masker unit to perform fixed function triangle and line rasterization. An associated render cache 1578 and depth cache 1579 are also available in some examples. A pixel operations component 1577 performs pixel-based operations on the data, though in some instances, pixel operations associated with 2D operations (e.g., bit block image transfers with blending) are performed by the 2D engine 1541, or substituted at display time by the display controller 1543 using overlay display planes. In some examples, a shared L3 cache 1575 is available to all graphics components, allowing the sharing of data without the use of main system memory.

In some examples, graphics processor media pipeline 1530 includes a media engine 1537 and a video front-end 1534. In some examples, video front-end 1534 receives pipeline commands from the command streamer 1503. In some examples, media pipeline 1530 includes a separate command streamer. In some examples, video front-end 1534 processes media commands before sending the command to the media engine 1537. In some examples, media engine 1537 includes thread spawning functionality to spawn threads for dispatch to thread execution logic 1550 via thread dispatcher 1531.

In some examples, graphics processor 1500 includes a display engine 1540. In some examples, display engine 1540 is external to processor 1500 and couples with the graphics processor via the ring interconnect 1502, or some other interconnect bus or fabric. In some examples, display engine 1540 includes a 2D engine 1541 and a display controller 1543. In some examples, display engine 1540 contains special purpose logic capable of operating independently of the 3D pipeline. In some examples, display controller 1543 couples with a display device (not shown), which may be a system integrated display device, as in a laptop computer, or an external display device attached via a display device connector.

In some examples, the geometry pipeline 1520 and media pipeline 1530 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### FURTHER EXAMPLES

Example 1 provides an exemplary method comprising: broadcasting a first plurality of credit grants to a plurality of circuits of a computing device based on availability of credits for packet transmission to a first circuit of the computing system through a fabric that couples the first circuit and the plurality of circuits; receiving a credit request from a second circuit of the computing system to obtain a credit for packet transmission of a traffic class from the second circuit through the fabric to the first circuit; and responsive to the credit request and based on available credits dedicated to or shared with the traffic class for packet transmission to the first circuit, performing credit granting of: sending a credit grant only to the second circuit for packet transmission of the traffic class to the first circuit, or broadcasting a second plurality of credit grants to the plurality of circuits for packet transmission to the first circuit of the traffic class, including a credit grant to the second circuit.

Example 2 includes the substance of Example 1, wherein the availability of credits is determined based on comparing one or more thresholds with how many credits are available for packet transmission to the first circuit.

Example 3 includes the substance of Examples 1 to 2, wherein the one or more thresholds are determined based on a machine learning model.

Example 4 includes the substance of Examples 1 to 3, wherein the availability of credits is determined based on a percentage of available credits within credit grants allocated to be dedicated one or more traffic classes or to be shared with multiple traffic classes for packet transmission to the first circuit.

Example 5 includes the substance of Examples 1 to 4, wherein the first plurality of credit grants is broadcasted to cause a number of remaining credits either dedicated one or more traffic classes or to be shared with multiple traffic classes for packet transmission to the first circuit to reach respective thresholds.

Example 6 includes the substance of Examples 1 to 5, wherein the availability of credits is determined based on availability of buffer storage of the first circuit for the packet transmission to the first circuit.

Example 7 includes the substance of Examples 1 to 6, wherein when a number of the available credits dedicated to or shared with the traffic class for packet transmission to the first circuit is below a threshold, the credit grant is to be sent to the second circuit only, otherwise the second plurality of credit grants are broadcast to the plurality of circuits.

Example 8 includes the substance of Examples 1 to 7, further comprising: responsive to that the credit grant to the first circuit has not been accepted within a time period, invaliding the credit grant and causing restoration of corresponding one or more credits.

Example 9 includes the substance of Examples 1 to 8, wherein the available credits dedicated to or shared with the traffic class for packet transmission to the first circuit increases upon completion of processing one or more packets at the first circuit, the one or more packets corresponding to one or more credits granted through the credit grant.

Example 10 includes the substance of Examples 1 to 9, wherein each of the first and second circuits comprises a processor core, a cache, and a system memory.

Example 11 provides a computing system comprising: a first circuit to receive packets; a plurality of circuits to transmit the packets to the first circuit; a fabric to couple the first and the plurality of circuits, the packets to be transmitted from the plurality of circuits to the first circuit through the fabric; and an arbiter circuit to: broadcast a first plurality of credit grants to the plurality of circuits based on availability of credits for packet transmission to the first circuit through the fabric receive a credit request from the second circuit of the plurality of circuits to obtain a credit for packet transmission of a traffic class from the second circuit through the fabric to the first circuit, and responsive to the credit request and based on available credits dedicated to or shared with the traffic class for packet transmission to the first circuit, perform credit granting of: sending a credit grant only to the second circuit for packet transmission of the traffic class to the first circuit, or broadcasting a second plurality of credit grants to the plurality of circuits for packet transmission to the first circuit of the traffic class, including a credit grant to the second circuit.

Example 12 includes the substance of Example 11, wherein the availability of credits is determined based on comparing one or more thresholds with how many credits are available for packet transmission to the first circuit.

Example 13 includes the substance of Examples 11 to 12, wherein the availability of credits is determined based on a percentage of available credits within credit grants allocated to be dedicated one or more traffic classes or to be shared with multiple traffic classes for packet transmission to the first circuit.

Example 14 includes the substance of Examples 11 to 13, wherein the first plurality of credit grants is broadcasted to cause a number of remaining credits either dedicated one or more traffic classes or to be shared with multiple traffic classes for packet transmission to the first circuit to reach respective thresholds.

Example 15 includes the substance of Examples 11 to 14, wherein when a number of the available credits dedicated to or shared with the traffic class for packet transmission to the first circuit is below a threshold, the credit grant is to be sent to the second circuit only, otherwise the second plurality of credit grants are broadcast to the plurality of circuits.

Example 16 provides an exemplary machine-readable storage medium storing instructions that when executed by a processor, are capable of performance of: broadcasting a first plurality of credit grants to a plurality of circuits of a computing device based on availability of credits for packet transmission to a first circuit of the computing system through a fabric that couples the first and the plurality of circuits; receiving a credit request from a second circuit of the computing system to obtain a credit for packet transmission of a traffic class from the second circuit through the fabric to the first circuit; and responsive to the credit request and based on available credits dedicated to or shared with the traffic class for packet transmission to the first circuit, performing credit granting of: sending a credit grant only to the second circuit for packet transmission of the traffic class to the first circuit, or broadcasting a second plurality of credit grants to the plurality of circuits for packet transmission to the first circuit of the traffic class, including a credit grant to the second circuit.

Example 17 includes the substance of Example 16, wherein the availability of credits is determined based on availability of buffer storage of the first circuit for the packet transmission to the first circuit.

Example 18 includes the substance of Examples 16 to 17, wherein the instructions when executed by a processor, are capable of causing further performance of: responsive to that the credit grant to the first circuit has not been accepted within a time period, invaliding the credit grant and causing restoration of corresponding one or more credits.

Example 19 includes the substance of Examples 16 to 18, wherein the available credits dedicated to or shared with the traffic class for packet transmission to the first circuit increases upon completion of processing one or more packets at the first circuit, the one or more packets corresponding to one or more credits granted through the credit grant.

Example 20 includes the substance of Examples 16 to 19, wherein each of the first and second circuits comprises a processor core, a cache, and a system memory.

### Additional Explanation

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method comprising:
broadcasting a first plurality of credit grants to a plurality of circuits of a computing system based on availability of credits for packet transmission to a first circuit of the computing system through a fabric that couples the first circuit and the plurality of circuits;
receiving a credit request from a second circuit of the computing system to obtain a credit for packet transmission of a traffic class from the second circuit through the fabric to the first circuit; and
responsive to the credit request and based on available credits dedicated to or shared with the traffic class for packet transmission to the first circuit, performing credit granting of:
sending a credit grant only to the second circuit for packet transmission of the traffic class to the first circuit, or
broadcasting a second plurality of credit grants to the plurality of circuits for packet transmission to the first circuit of the traffic class, including a credit grant to the second circuit.

2. The method of claim 1, wherein the availability of credits is determined based on comparing one or more thresholds with how many credits are available for packet transmission to the first circuit.

3. The method of claim 2, wherein the one or more thresholds are determined based on a machine learning model.

4. The method of claim 1, wherein the availability of credits is determined based on a percentage of available credits within credit grants allocated to be dedicated one or more traffic classes or to be shared with multiple traffic classes for packet transmission to the first circuit.

5. The method of claim 1, wherein the first plurality of credit grants is broadcasted to cause a number of remaining credits either dedicated one or more traffic classes or to be shared with multiple traffic classes for packet transmission to the first circuit to reach respective thresholds.

6. The method of claim 1, wherein the availability of credits is determined based on availability of buffer storage of the first circuit for the packet transmission to the first circuit.

7. The method of claim 1, wherein when a number of the available credits dedicated to or shared with the traffic class for packet transmission to the first circuit is below a threshold, the credit grant is to be sent to the second circuit only, otherwise the second plurality of credit grants are broadcast to the plurality of circuits.

8. The method of claim 1, further comprising:
responsive to that the credit grant to the first circuit has not been accepted within a time period, invaliding the credit grant and causing restoration of corresponding one or more credits.

9. The method of claim 1, wherein the available credits dedicated to or shared with the traffic class for packet transmission to the first circuit increases upon completion of processing one or more packets at the first circuit, the one or more packets corresponding to one or more credits granted through the credit grant.

10. The method of claim 1, wherein each of the first and second circuits comprises a processor core, a cache, and a system memory.

11. A computing system comprising:
a first circuit to receive packets;
a plurality of circuits to transmit the packets to the first circuit;
a fabric to couple the first and the plurality of circuits, the packets to be transmitted from the plurality of circuits to the first circuit through the fabric; and
an arbiter circuit to:
broadcast a first plurality of credit grants to the plurality of circuits based on availability of credits for packet transmission to the first circuit,
receive a credit request from a second circuit of the plurality of circuits to obtain a credit for packet transmission of a traffic class from the second circuit through the fabric to the first circuit, and
responsive to the credit request and based on available credits dedicated to or shared with the traffic class for packet transmission to the first circuit, perform credit granting of:
sending a credit grant only to the second circuit for packet transmission of the traffic class to the first circuit, or
broadcasting a second plurality of credit grants to the plurality of circuits for packet transmission to the first circuit of the traffic class, including a credit grant to the second circuit.

12. The computing system of claim 11, wherein the availability of credits is determined based on comparing one or more thresholds with how many credits are available for packet transmission to the first circuit.

13. The computing system of claim 11, wherein the availability of credits is determined based on a percentage of available credits within credit grants allocated to be dedicated one or more traffic classes or to be shared with multiple traffic classes for packet transmission to the first circuit.

14. The computing system of claim 11, wherein the first plurality of credit grants is broadcasted to cause a number of remaining credits either dedicated one or more traffic classes or to be shared with multiple traffic classes for packet transmission to the first circuit to reach respective thresholds.

15. The computing system of claim 11, wherein when a number of the available credits dedicated to or shared with the traffic class for packet transmission to the first circuit is below a threshold, the credit grant is to be sent to the second circuit only, otherwise the second plurality of credit grants are broadcast to the plurality of circuits.

16. A non-transitory machine-readable storage medium storing instructions that when executed by a processor, are capable of causing performance of:
broadcasting a first plurality of credit grants to a plurality of circuits of a computing system based on availability of credits for packet transmission to a first circuit of the computing system through a fabric that couples the first circuit and the plurality of circuits;
receiving a credit request from a second circuit of the computing system to obtain a credit for packet transmission of a traffic class from the second circuit through the fabric to the first circuit; and
responsive to the credit request and based on available credits dedicated to or shared with the traffic class for packet transmission to the first circuit, performing credit granting of:
sending a credit grant only to the second circuit for packet transmission of the traffic class to the first circuit, or
broadcasting a second plurality of credit grants to the plurality of circuits for packet transmission to the first circuit of the traffic class, including a credit grant to the second circuit.

17. The non-transitory machine-readable storage medium of claim 16, wherein the availability of credits is determined based on availability of buffer storage of the first circuit for the packet transmission to the first circuit.

18. The non-transitory machine-readable storage medium of claim 16, wherein the instructions when executed by a processor, are capable of causing further performance of:
responsive to that the credit grant to the first circuit has not been accepted within a time period, invaliding the credit grant and causing restoration of corresponding one or more credits.

19. The non-transitory machine-readable storage medium of claim 16, wherein the available credits dedicated to or shared with the traffic class for packet transmission to the first circuit increases upon completion of processing one or more packets at the first circuit, the one or more packets corresponding to one or more credits granted through the credit grant.

20. The non-transitory machine-readable storage medium of claim 16, wherein each of the first and second circuits comprises a processor core, a cache, and a system memory.
